(19) United States
(12) Patent Application Publication
(10) Pub. No.: US 2025/0145769 A1
(43) Pub. Date: May 8, 2025

(54) CROSS-LINKED ARYLIMIDAZOLIUM POLYMERS AND USES THEREOF

(71) Applicant: IONOMR INNOVATIONS INC., Vancouver (CA)

(72) Inventors: Bobak Gholamkhass, North Vancouver (CA); Benjamin Britton, Vancouver (CA); Deepak Shukla, Webster, NY (US)

(73) Assignee: IONOMR INNOVATIONS INC., Vancouver (CA)

(21) Appl. No.: 18/933,694

(22) Filed: Oct. 31, 2024

Related U.S. Application Data
(60) Provisional application No. 63/595,958, filed on Nov. 3, 2023.

(51) Int. Cl. C08G 73/06; B01D 67/00; B01D 69/02; B01D 71/58; B01J 41/13; B01J 47/12; C25B 13/08; H01M 8/10; H01M 8/103; H01M 8/1072; H01M 8/1081; H01M 8/18

(52) U.S. Cl. CPC C08G 73/0616; B01D 67/0013; B01D 67/0018; B01D 69/02; B01D 71/58; B01J 41/13; B01J 47/12; C25B 13/08; H01M 8/103; H01M 8/1072; H01M 8/1081; H01M 8/188; B01D 2323/081; B01D 2323/12; B01D 2323/30; B01D 2325/04; B01D 2325/42; H01M 2008/1095

(57) ABSTRACT

The present disclosure features a crosslinked arylimidazolium polymer membrane, the method of making, and uses thereof. The disclosed crosslinked arylimidazolium polymer membrane yields desirable mechanical properties, and can be incorporated into an electrochemical device such as a fuel cell, an electrolyzer, a redox flow battery, or another electrochemical device.

### CROSS-REFERENCE TO RELATED APPLICATION

This application claims the benefit of U.S. Application No. 63/595,958, filed on Nov. 3, 2023, the disclosure of which is hereby incorporated by reference in its entirety.

### FIELD OF THE INVENTION

The present invention relates to a cross-linked anion exchange membrane (X-AEM) comprising arylimidazolium polymers, a method for manufacturing the X-AEM, and uses thereof. The AEM can be used in electrochemical devices such as fuel cells, electrolyzers, redox flow batteries, or other electrochemical devices.

### BACKGROUND

Electrochemical devices include, but are not limited to, fuel cells, electrolyzers, redox flow batteries, and electrochemical compressors. Ion exchange membranes can be used with all such devices. For example, electrochemical devices can use proton exchange membranes (PEM).

Ion exchange membranes, whether AEM or PEM, transport anions or cations, respectively, when an electrical or chemical potential exists across the membrane. Ion exchange membranes have either negatively charged groups (for PEM) or positively charged groups (for AEM) attached to the polymeric material comprising the bulk of the membrane. The counterion of each charged membrane is the transferable ion.

A cation exchange membrane (e.g., PEM) has fixed negative charges, and positively charged mobile cations. Similarly, anion exchange membranes (AEMs) have fixed positively charged groups, and negatively charged mobile anions. AEMs allow the transfer of, for example, HO⁻, while PEMs allow transport of, for example, H⁺ ions.

Efficient operation of applications and systems utilizing PEMs requires an acidic environment, which is highly corrosive and not sustainable for all system components. An additional drawback of traditional PEM-containing systems is dependency upon platinum group metal (PGM) catalysts.

An application which utilizes ion exchange membranes is water electrolysis. Electrolysis of water is well-known, having occurred since the 1800s. In such an application, liquid alkaline and PEM electrolyzers have traditionally been utilized.

Desired properties for ion exchange membranes in devices such as electrolyzers include chemical and mechanical stability, low hydrogen crossover, low water uptake, and good conductivity.

Although some AEMs exist, such AEMs exhibit degradation of cationic functionalities by, e.g., Hofmann elimination or nucleophilic substitution, and are predominantly based on quaternary ammonium groups pendant to a polymer main chain, or “backbone”. The stability of quaternary ammonium groups is often poor in highly alkaline solutions, and thus AEM-containing materials have demonstrated rapid degradation over time.

Additionally, hydroxide forms of AEM polymers are unstable. For example, quaternized poly(imidazolium) and poly(benzimidazolium) (PBI) polymers degrade upon immersion in basic aqueous solution by a ring-opening reaction at the C2 position of the imidazolium and benzimidazolium ring, respectively, leading to loss of cationic functionality and irreversible ring opening.

Although some benzimidazolium and imidazolium polymers can be stabilized by steric crowding around the benzimidazolium nitrogen atoms, or steric crowding around the benzimidazolium C2-position, such polymers are often water-soluble, which is an undesired polymer property for practical applications.

Applications utilizing ion exchange membranes require certain levels of ion conductivity. A way to enhance ion conductivity of AEMs is to increase the ion exchange capacity (IEC). However, because of severe membrane swelling of such membranes, which is caused by excessive water absorption, mechanical integrity of the AEMs is generally compromised at high IEC.

Crosslinking of AEMs can limit water sorption and/or increase mechanical stability. However, current crosslinking methods require long processing times (up to 36 hours), post-quaternization processes, and high temperatures, which is not compatible with large volume manufacturing.

Therefore, a need exists for ion exchange membranes which exhibit low hydrogen crossover, low water uptake, good conductivity, and high alkali stability; are less corrosive than PEMs and/or comprise more sustainable materials; and are quick, cost-effective to produce, and scalable.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, the present disclosure features a crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units each independently selected from Formula (I):

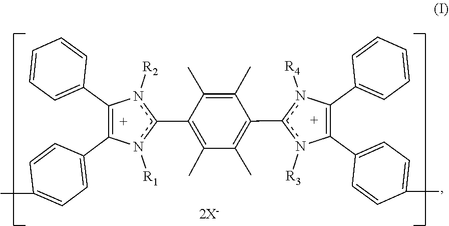

wherein:
R₁, R₂, R₃, and R₄ are each independently selected from C₁₋₈ alkyl and a crosslinking moiety, and
the crosslinked polymer membrane comprises about 90 wt % of the arylimidazolium polymer chains, and about 10 wt % of the one or more crosslinking moiety.

In another aspect, the present disclosure features a method of making a crosslinked polymer membrane, comprising:
preparing a casting solution of a plurality of arylimidazolium polymer chains, one or more crosslinker, and one or more solvent, and optionally adding KI, NaI, tetraalkyl ammonium iodide, or a combination thereof;
casting the casting solution onto a supporting substrate to form a film; and
heating the film at a temperature between about 80° C. and about 100° C. to form the crosslinked polymer membrane,
wherein:
the crosslinked polymer membrane comprises covalent bonds between the arylimidazolium polymer chains and a crosslinking moiety.

In a further aspect, the present disclosure features a crosslinked polymer membrane incorporated into a catalyst layer of a fuel cell, of an electrolyzer, or of another electrochemical device.

In yet another aspect, the present disclosure features an electrochemical device comprising a crosslinked polymer membrane, wherein the electrochemical device is a fuel cell, an electrolyzer, a redox flow battery, or another electrochemical device.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows inter-chain covalent binding to generate a cross-linked network of the polymer in a membrane with an alkyl crosslinking moiety from a diiodoalkane crosslinker. For simplicity, only one repeating unit is shown.

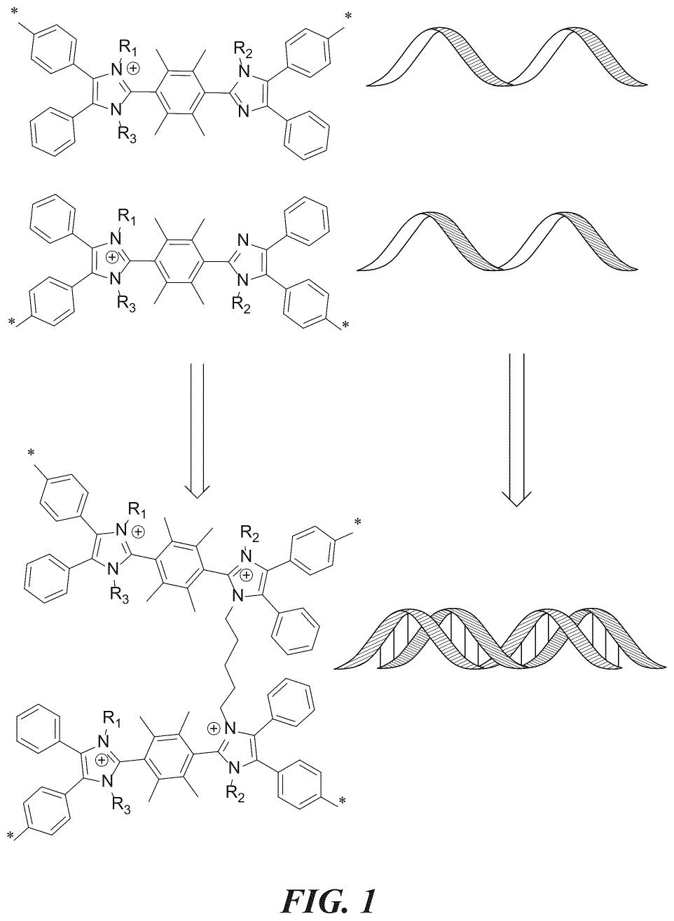

### DETAILED DESCRIPTION

The object of the present invention is to provide a composition and method for making a crosslinked arylimidazolium polymer-based anion exchange membrane (X-AEM) for use with, but not restricted to, electrochemical devices such as fuel cells, electrolyzers, and redox flow batteries.

A benefit of AEM systems, such as AEM electrolyzers, is the ability to use a mildly alkaline environment, which is far less corrosive than the harsh acidic environments of devices comprising PEMs.

AEM systems have advantages over PEM systems. AEM systems lack dependency on platinum group metal (PGM) catalysts and are less corrosive than PEM systems. Consequently, AEM systems allow usage of cheaper, and/or more sustainable materials for device components.

Crosslinking of AEMs provides material advantages such as decreased reactant/solvent permeability and improved chemical stability. Additionally, cross-linked AEMs, when doped with KOH, possess a lower solubility, increased elastic modulus, and increased chemical stability against oxidative radicals and hydroxide.

Covalent crosslinking of AEMs by the methods disclosed herein, especially AEMs with high IEC values, minimizes membrane swelling and reduces opportunities for HO to attack either the polymer backbone or the functional groups, thus leading to enhanced mechanical and alkaline stability.

### Definitions

The terminology used in the description of the invention herein is for the purpose of describing particular embodiments and is not intended to be limiting for the invention.

It is further appreciated that certain features of the disclosure, which are, for clarity, described in the context of separate embodiments, can also be provided in combination in a single embodiment. Conversely, various features of the disclosure which are, for brevity, described in the context of a single embodiment, can also be provided separately or in any suitable subcombination.

Substituents of polymers of the disclosure are disclosed herein in groups or in ranges. It is specifically intended that the disclosure include each and every individual subcombination of the members of such groups and ranges. For example, the term “C₁₋₈ alkyl” is specifically intended to individually disclose (without limitation) methyl, ethyl, C₃ alkyl, C₄ alkyl, C₅ alkyl, C₆ alkyl, C₇ alkyl, and C₈ alkyl, and include linear or branched geometric isomers when such geometric isomers are possible. For example, C₄ alkyl can be n-butyl, sec-butyl, isobutyl, or tert-butyl.

As used herein, the term “alkyl” refers to straight or branched hydrocarbon groups. In some embodiments, alkyl has 1 to 8 carbon atoms, 1 to 7 carbon atoms, 1 to 6 carbon atoms, 1 to 5 carbon atoms, 1 to 4 carbon atoms, 1 to 3 carbon atoms, 1 or 2 carbon atoms, or 1 carbon atom. Representative alkyl groups include methyl, ethyl, propyl (e.g., n-propyl, isopropyl), butyl (e.g., n-butyl, sec-butyl, isobutyl, and tert-butyl), pentyl (e.g., n-pentyl, tert-pentyl, neopentyl, isopentyl, pentan-2-yl, pentan-3-yl), hexyl (e.g., n-hexyl, geometric isomers), and octyl (e.g., n-octyl, geometric isomers) groups.

As used herein, “substituted” means that an atom or group of atoms formally replaces hydrogen as a “substituent.” The term “substituted” means that at least one hydrogen atom is replaced with a non-hydrogen substituent. Additionally, a compound can be substituted with a hydrogen, and hydrogen can be a substituent. The term “substituted,” unless otherwise indicated, refers to any level of substitution, e.g., mono-, di-, tri-, tetra-, penta-, or higher substitution, where such substitution is permitted. The substituents are independently selected, and substitution may be at any chemically accessible position. It is to be understood that substitution at a given atom is limited by valency.

As used herein, “alcohol” means a hydrocarbon molecule comprising one hydroxyl (HO⁻) functional group. Examples of alcohols include ethanol, propanol, isopropanol, 1-butanol, 2-butanol, 2-methyl-1-propanol, 2-methyl-2-propanol, etc.

As used herein, “gel” means an aggregate polymer network that is filled with a solvent.

As used herein, “solid” means a yet to dissolve, or insoluble, component of a polymer.

As used herein, the term “repeat unit” or “repeating unit” corresponds to the smallest monomeric unit, the repetition, or plurality, of which constitutes a macromolecule, or a polymer chain. The monomeric unit is a repeat unit within the polymer chain. As used herein, monomeric unit and repeat are used interchangeably. The monomeric unit of a polymer chain refers to a group of atoms in the monomer which comprise the backbone, together with its pendant atoms or groups of atoms. The monomeric units in a polymer chain may be the same, or may be different. For example, any monomeric unit can comprise three alkyl R groups and one crosslinking moiety; two alkyl R groups and two crosslinking moieties; and/or one alkyl R group and three crosslinking moieties. Any monomeric unit can comprise four, three, two, or only one alkyl R groups. Any monomeric unit can have four alkyl groups that are the same alkyl groups; four different alkyl groups that are different; and/or any combination of same and different alkyl R groups, including 1, 2, or 3 same R groups, and 1, 2, or 3 different R groups. The monomeric unit can also refer to an end group on the polymer chain. For example, the monomeric unit of polyethylene glycol can be —CH₂CH₂O— corresponding to a repeating unit, or —CH₂CH₂OH corresponding to an end group. As used herein, the term “end group” refers to a repeating unit, or monomeric unit, with only one attachment to the polymer chain, located at an end of the polymer chain.

As used herein, “polymer chain” corresponds to the connected plurality of repeat, or monomeric, units. A polymer chain is formed by the connection of monomeric units, for example, when one end of a monomeric unit backbone is connected to one end of another monomeric unit backbone. One or more polymer chain can constitute the polymer of the polymer membrane. One polymer chain can differ from another polymer chain. For example, one polymer chain can be longer or shorter than another polymer chain, one polymer chain can comprise different monomeric units than another polymer chain, one polymer chain can comprise a different arrangement of monomeric units than another polymer chain, one polymer chain can have a different degree of alkylation on the nitrogen atoms compared with another polymer chain, one polymer chain can comprise a different quantity of crosslinking moieties compared with another polymer chain, one polymer chain can comprise different crosslinking moieties compared with another polymer chain, one polymer chain can comprise greater or fewer crosslinking moieties within the polymer chain or between polymer chains compared with another polymer chain, one polymer chain can have a different 3-dimensional structure compared with another polymer chain, and/or a polymer chain can differ from another polymer chain in yet another way.

As used herein, the term “cationic” refers to a moiety that is positively charged, or ionizable to a positively charged moiety under chemical or acidic conditions relative to the pKa of an atom. Examples of cationic moieties include, for example, ammonium, iminium, imidazolium, oxazolium, thiazolium groups, etc.

As used herein, the term “anionic” refers to a functional group that is negatively charged, or ionizable to a negatively charged moiety under chemical or basic conditions relative to the pKa of an atom. Examples of anionic groups include halide, carboxylate, hydroxide, etc.

A weight percent (wt %) of a component is based on the weight relative to another component of the composition or solution in which the component is included. Unless specified otherwise, weight percent is intended to constitute the weight of a composition in its dry form.

As used herein, “molecular weight,” or “MW,” refers to number-average molecular weight which can be measured by ¹H NMR spectroscopy, gel permeation chromatography (GPC), viscosity, falling ball viscosity, or other analytical methods. Differences in molecular weights of a polymer synthesized by the same method may be estimated by comparing viscosity of polymer solutions.

As used in the description of the invention and the appended claims, the singular forms “a”, “an” and “the” are intended to include the plural forms as well, unless the context clearly indicates otherwise.

As used herein, the term “about” can be understood to include values within 10% of the stated value. For example, a crosslinked polymer membrane comprising about 90 wt % of arylimidazolium polymers, and about 10 wt % of crosslinking moiety means the polymer membrane comprises up to 90±9 wt %, or 81-99 wt %, of arylimidazolium polymers and 10±1 wt %, or 9-11 wt %, of the crosslinking moiety. In another example, a viscosity of about 7 cP means a viscosity of 7±0.7 cP, or a viscosity of 6.3-7.7 cP.

As used herein, “essentially” or “essentially the same” means “the same” when, unless otherwise stated, a variability of up to 10% exists. For example, two or more arylimidazolium polymer chains are “essentially” the same when the monomeric unit composition of the polymer chains deviates by, i.e., up to 10%. In another example, one polymer chain is essentially the same as another polymer chain when the average extent of alkylation differs by up to 10%, such as when one polymer chain is 100% alkylated and another polymer chain 90% alkylated. In another example, two polymer chains are essentially the same when their monomeric composition is essentially the same, but the crosslinking differs in its location, or extent. In another example, two or more arylimidazolium polymers are “essentially” the same when their monomeric composition is essentially the same but the two polymers deviate by, e.g., their molecular weight, average molecular weight, or number of repeat units.

It is further intended that the polymers of the disclosure are stable. In the context of the present invention, “stable” refers to a polymer that can withstand heating an aqueous solution at pH>10 and 80° C. for at least 24 hours without degradation. The “stability” of the polymer can be verified by analyzing its ¹H NMR spectrum after heating at these conditions and comparing it to that of the pristine polymer.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the present application and relevant art, and should not be interpreted in an idealized or overly formal sense unless expressly so defined herein.

### Polymer Membranes

Polymer membranes having high hydroxide (HO⁻) ionic conductivity and caustic stability, as well as desirable mechanical properties, are presented. In some embodiments, the anion exchange membranes (AEMs) comprise poly(aryl-imidazolium) backbones with N-alkyl side chains, and are referred to as arylimidazolium polymers.

In one aspect, a crosslinked polymer membrane is provided. The crosslinked polymer membrane comprises a crosslinked arylimidazolium polymer, wherein the crosslinked arylimidazolium polymer comprises one or a plurality of arylimidazolium polymer chains and one or more crosslinking moiety.

Each arylimidazolium polymer chain of the plurality of arylimidazolium polymer chains comprises a plurality of repeat units, or monomeric units, which make up each arylimidazolium polymer chain.

In an embodiment, each arylimidazolium polymer chain of the plurality of arylimidazolium polymer chains comprises a plurality of repeat units, wherein each repeat unit is independently selected from Formula (I):

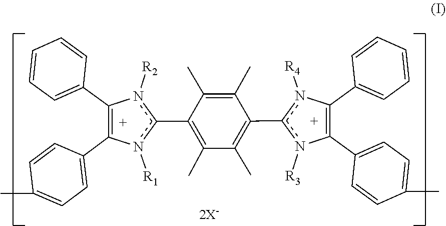

wherein:
R₁, R₂, R₃, and R₄ are each independently selected from C₁₋₈ alkyl and a crosslinking moiety, and
the crosslinked polymer membrane comprises about 60 wt % to about 95 wt % of the two or more arylimidazolium polymers, and about 5 wt % to about 40 wt % of the one or more crosslinking moiety.

In another aspect, a crosslinked polymer membrane is provided, wherein each arylimidazolium polymer chain of the plurality of arylimidazolium polymer chains comprises a plurality of repeat units wherein each repeat unit is independently selected from Formula (I):

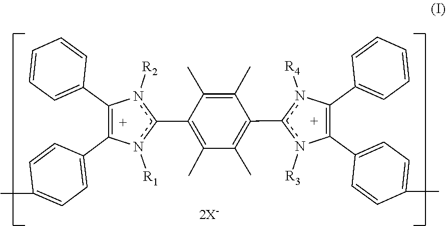

wherein:
R₁, R₂, R₃, and R₄ are each independently selected from C₁₋₈ alkyl and a crosslinking moiety, and
the crosslinked polymer membrane comprises about 90 wt % of the arylimidazolium polymer chains, and about 10 wt % of the one or more crosslinking moiety.

In some embodiments of Formula (I), R₁, R₂, R₃, and R₄ of each repeat unit are each independently selected from C₁₋₈ alkyl and a crosslinking moiety.

In some embodiments, any of the C₁-C₈ alkyl are linear, or branched if branching is geometrically possible (e.g., C₃ alkyl can be n-propyl or isopropyl; C₄ alkyl can be n-butyl, isobutyl, sec-butyl, or tert-butyl; and so forth). In some embodiments, R₁, R₂, R₃, and R₄ are each independently linear or branched C₃₋₈ alkyl. In some embodiments, R₁, R₂, R₃, and R₄ are each independently linear or branched C₃₋₆ alkyl.

In some embodiments, R₁, R₂, R₃, and R₄ are the same C₁₋₈ alkyl. In some embodiments, R₁, R₂, R₃, and R₄ are the same C₃₋₈ alkyl. In some embodiments, R₁, R₂, R₃, and R₄ are the same C₂₋₆ alkyl.

In some embodiments, R₁, R₂, R₃, and R₄ are not all the same C₁₋₈ alkyl. In some embodiments, R₁, R₂, R₃, and R₄ are not all the same C₃₋₈ alkyl. In some embodiments, R₁, R₂, R₃, and R₄ are not all the same C₂₋₆ alkyl. For example, in some embodiments, two of R₁, R₂, R₃, and R₄ are different from two of R₁, R₂, R₃, and R₄. In some embodiments, R₁ is different from R₂, and R₃ is different from R₄.

In some embodiments, one or more of R₁ and R₂ is methyl, and one or more of R₃ and R₄ is methyl. In some embodiments, one R₁ and R₂ is methyl, and one R₃ and R₄ is methyl.

In some embodiments, one or more of R₁ and R₂ is C₂₋₆ alkyl, and one or more of R₃ and R₄ is C₂₋₆ alkyl. In some embodiments, one of R₁ and R₂ is C₂₋₆ alkyl, and one of R₃ and R₄ is C₂₋₆ alkyl. In some embodiments, one or more of R₁ and R₂ is n-butyl, and one or more of R₃ and R₄ is n-butyl. In some embodiments, one of R₁ and R₂ is n-butyl, and one of R₃ and R₄ is n-butyl.

In some embodiments, one of R₁ and R₂ is methyl, one of R₁ and R₂ is n-butyl, one of R₃ and R₄ is methyl, and one of R₃ and R₄ is n-butyl.

In some embodiments, R₁ and R₄ are methyl, and R₂ and R₃ are n-butyl. In some embodiments, each repeat unit has a structure of Formula (II):

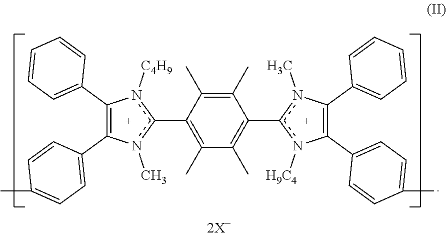

In some embodiments, the arylimidazolium polymer repeat units each comprise two, or about two, counterions X⁻. In some embodiments, the two counterions X⁻ of each repeat unit are the same or are different. In some embodiments, as between the repeat units, the counterions X⁻ are the same or are different. In some embodiments, the counterions X⁻ between the arylimidazolium polymer chains are the same or are different. For example, one arylimidazolium polymer chain can comprise a combination of counterions X⁻, and the combination of counterions X⁻ can be the same as, or different from, the combination of counterions X⁻ of a second arylimidazolium polymer chain.

In some embodiments, the counterion X is selected from the group consisting of F⁻, Cl⁻, Br⁻, I⁻, HO⁻, BF₄⁻, PF₆⁻, HCO₃⁻, CH₃CO₂⁻, CH₃SO₃⁻, C₂H₅SO₃⁻, CH₃C₆H₄SO₃⁻ (tosylate), NO₃⁻, and a combination thereof.

In some embodiments, X⁻ is Cl⁻. In some embodiments, X⁻ is I⁻. In some embodiments, X⁻ is NO₃⁻. In some embodiments, X⁻ is a combination of Cl⁻ and I⁻. In some embodiments, X⁻ is a combination of I⁻ and NO₃⁻. In a preferred embodiment, X⁻ is NO₃⁻.

In some embodiments, each repeat unit has a structure of Formula (III):

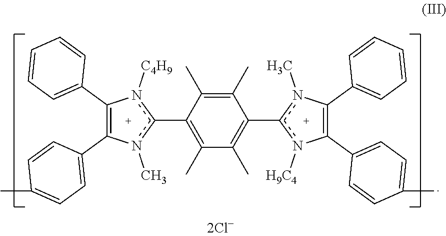

In some embodiments, the arylimidazolium polymer chain comprises a repeat unit of Formula (IV):

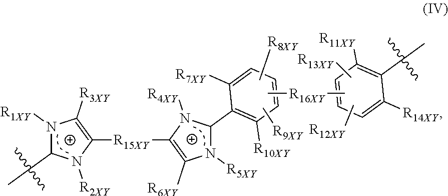

wherein R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
   at least one of R_{1XY} and R_{2XY} is selected from alkyl, perfluoroalkyl, heteroalkyl, aryl, and aralkyl,
   when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
   at least one of R_{4XY} and R_{5XY} is selected from alkyl, perfluoroalkyl, heteroalkyl, aryl, and aralkyl, and
   when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{15XY} is selected from alkylene, perfluoroalkylene, heteroalkylene, arylene, aralkylene, and heteroarylene, each optionally substituted with 1, 2, 3, or 4 substituents independently selected from alkyl, perfluoroalkyl, heteroalkyl, and halo;
R_{16XY} is selected from a bond, arylene, and heteroarylene, wherein said arylene and heteroarylene is each optionally substituted with 1, 2, 3, or 4 substituents independently selected from alkyl, perfluoroalkyl, heteroalkyl, and halo;
R_{7XY}, R_{10XY}, R_{11XY}, and R_{14XY} are each independently selected from H, alkyl, perfluoroalkyl, and heteroalkyl; and
R_{8XY}, R_{9XY}, R_{12XY}, and R_{13XY} are each independently selected from hydrogen (H), alkyl, perfluoroalkyl, and heteroalkyl.

In some embodiments, the arylimidazolium polymer comprises a repeat unit of Formula (V):

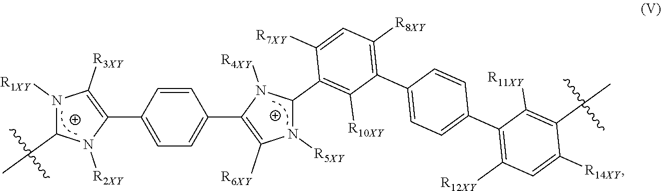

wherein:
R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
   at least one of R_{1XY} and R_{2XY} is selected from alkyl, perfluoroalkyl, heteroalkyl, aryl, and aralkyl,
   when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
   at least one of R_{4XY} and R_{5XY} is selected from alkyl, perfluoroalkyl, heteroalkyl, aryl, and aralkyl, and
   when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{7XY}, R_{10XY}, R_{11XY}, and R_{14XY} are each independently selected from H, alkyl, perfluoroalkyl, and heteroalkyl; and
R_{8XY} and R_{12XY} are each independently selected from hydrogen (H), alkyl, perfluoroalkyl, and heteroalkyl.

In some embodiments, the arylimidazolium polymer comprises a repeat unit of Formula (VI):

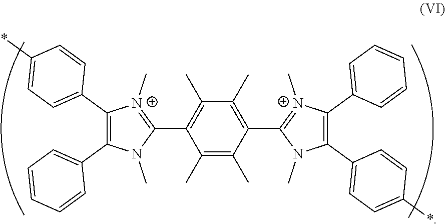

In some embodiments, the arylimidazolium polymer comprises a repeat unit of Formula (VII):

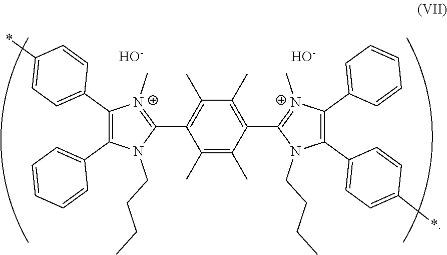

In some embodiments, the arylimidazolium polymer comprises a repeat unit of Formula (VIII):

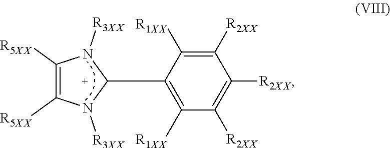

wherein:
R_{1XX} is independently selected from the group consisting of H, methyl, trifluoromethyl, alkyl, perfluoroalkyl, heteroalkyl, alkoxy, perfluoroalkoxy, halo, aryl, heteroaryl group, a crosslinking moiety, and a polymer;
R_{2XX} is independently selected from the group consisting of hydrogen, any group, and a polymer;
R_{3XX} is independently selected from the group consisting of methyl, trifluoromethyl, alkyl, perfluoroalkyl, heteroalkyl, aryl, alkyl, a polymer, and absent; and
R_{5XX} is independently selected from the group consisting of hydrogen, any group, and a polymer; and
wherein at least one of R_{1XX}, R_{2XX}, R_{3XX}, and R_{5XX}, is a polymer.

In some embodiments, the arylimidazolium polymer comprises a repeat unit of an imidazolium having a formula as disclosed in PCT Publication Nos. WO 2022/193030, WO 2013/149328, WO2018/026743, and WO2018/023097, each of which is herein incorporated by reference in its entirety.

In some embodiments, the crosslinked arylimidazolium polymer comprises one arylimidazolium polymer chain.

In some embodiments, the crosslinked arylimidazolium polymer comprises two or more arylimidazolium polymer chains, each of which comprise the same, or essentially the same, repeat units; each of which comprise different repeat units; or a combination thereof.

In some embodiments, each chain of the plurality of arylimidazolium polymer chains is the same. In some embodiments, each chain of the plurality of arylimidazolium polymer chains is different. In some embodiments, two or more chains of the plurality of arylimidazolium polymer chains are the same and two or more chains are different.

In some embodiments, one or more arylimidazolium polymer chains of the plurality of arylimidazolium polymer chains comprises a repeat unit, and one or more of the arylimidazolium polymer chains comprises one or more different repeat unit.

In some embodiments, an arylimidazolium polymer chain comprises the same, or essentially the same, repeat units, and a second arylimidazolium polymer chain comprises the same, or essentially the same, repeat units, wherein the repeat units of each polymer chain are different.

In some embodiments, an arylimidazolium polymer chain comprises a combination of repeat units, and a second arylimidazolium polymer chain comprises a different combination of repeat units. In some embodiments, at least two arylimidazolium polymer chains comprise one or more different repeat units from each other.

In some embodiments, two or more repeat units in an arylimidazolium polymer chain are the same and two or more repeat units in the same arylimidazolium polymer chain are different.

In some embodiments, each of the arylimidazolium polymer chains comprise imidazole nitrogen atoms. In some embodiments, at least about 85%, at least about 90%, about 91% to about 99%, about 90%, about 91%, about 92%, about 93%, about 94%, about 95%, about 96%, about 97%, about 98%, or about 99% of the nitrogen atoms are alkylated. In some embodiments, at least about 90% of the nitrogen atoms are alkylated. In some embodiments, about 90% to about 99% of the nitrogen atoms are alkylated. In some embodiments, the nitrogen atoms are alkylated with C₁₋₈ alkyl.

In some embodiments, at least about 45% of the nitrogen atoms are methylated and at least about 45% of the nitrogen atoms are alkylated with C₂₋₆ alkyl. In some embodiments, at least about 45% of the nitrogen atoms are methylated and at least about 45% of the nitrogen atoms are butylated.

In some embodiments, the crosslinked arylimidazolium polymer comprises one or more crosslinking moiety. In some embodiments, the arylimidazolium crosslinked polymer comprises more than one crosslinking moiety wherein at least two of the crosslinking moieties are the same. In some embodiments, the arylimidazolium crosslinked polymer comprises more than one crosslinking moiety wherein at least two of the crosslinking moieties are different. In some embodiments, the arylimidazolium crosslinked polymer comprises more than one crosslinking moiety wherein at least two of the crosslinking moieties are the same and at least two of the crosslinking moieties are different.

In some embodiments, about 1% to about 50% of the arylimidazolium polymer chains are crosslinked with one or more crosslinking moieties. In some embodiments, about 1% to about 30% of the arylimidazolium polymer chains are crosslinked with one or more crosslinking moieties. In some embodiments, about 1% to about 20% of the arylimidazolium polymer chains are crosslinked with one or more crosslinking moieties. In some embodiments, about 1% to about 10% of the arylimidazolium polymer chains are crosslinked with one or more crosslinking moieties.

In some embodiments, one or more of R₁, R₂, R₃, and R₄ of Formula (I) is a crosslinking moiety. In some embodiments, one of R₁, R₂, R₃, and R₄ of Formula (I) is a crosslinking moiety. In some embodiments, two of R₁, R₂, R₃, and R₄ of Formula (I) are crosslinking moieties. In some embodiments, three of R₁, R₂, R₃, and R₄ of Formula (I) are crosslinking moieties. In some embodiments, four of R₁, R₂, R₃, and R₄ of Formula (I) are crosslinking moieties.

In some embodiments, the crosslinking moiety is covalently bound to one or more arylimidazolium polymer chain.

In some embodiments, the arylimidazolium polymers are intermolecularly crosslinked, intramolecularly crosslinked, or a combination thereof.

In some embodiments, the one or more crosslinking moiety is covalently bound to a nitrogen atom of a first arylimidazolium polymer chain, and a nitrogen atom of a second arylimidazolium polymer chain. In some embodiments, the one or more crosslinking moiety is covalently bound to a first nitrogen atom of an arylimidazolium polymer chain, and a second nitrogen atom of the same arylimidazolium polymer chain. In some embodiments, the crosslinked arylimidazolium polymer comprises a combination of crosslinking both within an arylimidazolium polymer chain and between arylimidazolium polymer chains.

In some embodiments, the one or more crosslinking moiety is a substituted or unsubstituted 1,3-propane, a substituted or unsubstituted 1,6-hexane, a substituted or unsubstituted 1,8-octane, a substituted or unsubstituted 1,10-decane, a substituted or unsubstituted 1,12-dodecane, a substituted or unsubstituted 1,14-tetradecane, a substituted or unsubstituted α,α′-p-xylene, or a combination thereof.

In some embodiments, the one or more crosslinking moiety is an unsubstituted 1,6-hexane.

In some embodiments, the one or more crosslinking moiety is a substituted 1,6-hexane.

In some embodiments, the one or more crosslinking moiety is an unsubstituted 1,8-octane.

In some embodiments, the one or more crosslinking moiety is a substituted 1,8-octane.

In some embodiments, the arylimidazolium polymer comprises both 1,6-hexane and 1,8-octane crosslinking moieties.

In some embodiments, the substituted 1,3-propane, 1,6-hexane, 1,8-octane, 1,10-decane, 1,12-dodecane, 1,14-tetradecane, and α,α′-p-xylene are each independently substituted with C₁-C₆ alkyl.

In some embodiments, the substituted 1,6-hexane is substituted with C₁-C₆ alkyl.

In some embodiments, the substituted 1,8-octane is substituted with C₁-C₆ alkyl.

In some embodiments, the C₁-C₆ alkyl substituents are linear or branched when geometrically possible. For example, a C₄ alkyl can be n-butyl, isobutyl, sec-butyl, or tert-butyl.

The number or amount of crosslinking moieties in the crosslinked arylimidazolium polymer is represented as weight percent (wt %) of the crosslinking moiety and is the weight percent relative to the weight percent of the plurality of arylimidazolium polymer chains.

In some embodiments, the crosslinked arylimidazolium polymer comprises about 60 wt % to about 95 wt % of the plurality of arylimidazolium polymer chains, and about 5 wt % to about 40 wt % of the crosslinking moiety. In some embodiments, the crosslinked arylimidazolium polymer comprises about 75 wt % to about 95 wt % of the plurality of arylimidazolium polymer chains, and about 5 wt % to about 25 wt % of the crosslinking moiety. In some embodiments, the crosslinked arylimidazolium polymer comprises about 80 wt % to about 95 wt % of the plurality of arylimidazolium polymer chains, and about 5 wt % to about 20 wt % of the crosslinking moiety. In some embodiments, the crosslinked arylimidazolium polymer comprises about 85 wt % to about 95 wt % of the plurality of arylimidazolium polymer chains, and about 5 wt % to about 15 wt % of the crosslinking moiety. In some embodiments, the crosslinked arylimidazolium polymer comprises about 88 wt % to about 92 wt % of the plurality of arylimidazolium polymer chains, and about 8 wt % to about 12 wt % of the crosslinking moiety. In some embodiments, the crosslinked arylimidazolium polymer comprises about 89 wt % to about 91 wt % of the plurality of arylimidazolium polymer chains, and about 9 wt % to about 11 wt % of the crosslinking moiety. In some embodiments, the crosslinked arylimidazolium polymer comprises at least about 85 wt % of the plurality of arylimidazolium polymer chains, and up to about 15 wt % of the crosslinking moiety. In some embodiments, the crosslinked arylimidazolium polymer comprises no more than about 95 wt % of the plurality of arylimidazolium polymer chains, and at least about 5 wt % of the crosslinking moiety. In some embodiments, the crosslinked arylimidazolium polymer comprises about 90 wt % of the plurality of arylimidazolium polymer chains, and about 10 wt % of the crosslinking moiety. In the foregoing embodiments, wherein a weight percent of the arylimidazolium polymer chains and a weight percent of crosslinking moiety are provided, it is intended the weight percent of the arylimidazolium polymer chains and the weight percent of the crosslinking moiety together equal 100 wt %, or equal about 100 wt %.

Alternatively, the weight percent of the plurality of arylimidazolium polymer chains to the weight percent of the crosslinking moiety could be expressed as a ratio. For example, a 90 wt % of arylimidazolium polymer chains and 10 wt % of crosslinking moiety could instead be expressed as a 90:10 ratio of the arylimidazolium polymer chains to the crosslinking moiety.

In some embodiments, the plurality of arylimidazolium polymer chains is comprised of an average number of repeat units.

In some embodiments, the plurality of arylimidazolium polymer chains have an average molecular weight of between about 100 kDa and about 2000 kDa, between about 100 kDa and about 1000 kDa, between about 100 kDa and about 800 kDa, between about 100 kDa and about 600 kDa, between about 100 kDa and about 400 kDa, between about 100 kDa and about 300 kDa, between about 100 kDa and about 200 kDa, between about 100 kDa and about 180 kDa, between about 100 kDa and about 160 kDa, between about 110 kDa and about 150 kDa, between about 120 kDa and about 140 kDa, at least about 100 kDa, at least about 120 kDa, no more than about 2000 kDa, no more than about 1000 kDa, no more than about 600 kDa, no more than about 400 kDa, no more than about 200 kDa, or no more than about 150 kDa, or about 130 kDa.

In some embodiments, the crosslinked polymer membrane further comprises one or more solvent, wherein the one or more solvent is a protic solvent having a boiling point of between about 70° C. and about 500° C. at atmospheric pressure. In some embodiments, the crosslinked polymer membrane further comprises one or more solvent, wherein the one or more solvent is an aprotic solvent having a boiling point of between about 70° C. and about 500° C. at atmospheric pressure. In some embodiments, the crosslinked polymer membrane further comprises both a protic solvent having a boiling point of between about 70° C. and about 500° C. at atmospheric pressure and an aprotic solvent having a boiling point of between about 70° C. and about 500° C. at atmospheric pressure.

In some embodiments, the crosslinked polymer membrane further comprises a protic organic solvent having a boiling point of between about 70° C. and about 500° C. at atmospheric pressure. In some embodiments, the crosslinked polymer membrane further comprises a diprotic organic solvent having a boiling point of between about 100° C. and about 500° C. at atmospheric pressure. In some embodiments, the crosslinked polymer membrane further comprises an aprotic organic solvent comprising a ketone and having a boiling point of between about 100° C. and about 500° C. at atmospheric pressure. In some embodiments, the crosslinked polymer membrane further comprises an aprotic organic solvent comprising a carbonate and having a boiling point of between about 100° C. and about 500° C. at atmospheric pressure. In some embodiments, the crosslinked polymer membrane further comprises a combination of any of a protic organic solvent having a boiling point of between about 70° C. and about 500° C. at atmospheric pressure, a diprotic organic solvent having a boiling point of between about 100° C. and about 500° C. at atmospheric pressure, an aprotic organic solvent comprising a ketone and having a boiling point of between about 100° C. and about 500° C. at atmospheric pressure, and an aprotic organic solvent comprising a carbonate and having a boiling point of between about 100° C. and about 500° C. at atmospheric pressure.

In some embodiments, the crosslinked polymer membrane has a thickness of up to about 200 μm. In some embodiments, the crosslinked polymer membrane has a thickness of up to about 100 μm. In some embodiments, the crosslinked polymer membrane has a thickness of up to about 80 μm. In some embodiments, the crosslinked polymer membrane has a thickness of up to about 60 μm. In some embodiments, the crosslinked polymer membrane has a thickness of at least about 20 μm. In some embodiments, the crosslinked polymer membrane has a thickness of at least about 40 μm. In some embodiments, the crosslinked polymer membrane has a thickness of between about 20 μm and about 200 μm. In some embodiments, the crosslinked polymer membrane has a thickness of between about 20 μm and about 100 μm. In some embodiments, the crosslinked polymer membrane has a thickness of between about 40 μm and about 80 μm. In some embodiments, the crosslinked polymer membrane has a thickness of between about 40 μm and about 60 μm. In some embodiments, the crosslinked polymer membrane has a thickness of between about 45 μm and about 55 μm. In some embodiments, the crosslinked polymer membrane has a thickness of between about 48 μm and about 52 μm. In some embodiments, the crosslinked polymer membrane has a thickness of between about 49 μm and about 51 μm. In some embodiments, the crosslinked polymer membrane has a thickness of about 50 μm.

In some embodiments, the crosslinked polymer membrane has a concentration of ion exchange groups between about 0.2 mmol/g to about 6 mmol/g of dry crosslinked arylimidazolium polymer. In some embodiments, the crosslinked polymer membrane has a concentration of ion exchange groups between about 0.2 mmol/g to about 2 mmol/g of dry crosslinked arylimidazolium polymer. In some embodiments, the crosslinked polymer membrane has a concentration of ion exchange groups between about 2 mmol/g to about 4 mmol/g of dry crosslinked arylimidazolium polymer. In some embodiments, the crosslinked polymer membrane has a concentration of ion exchange groups between about 4 mmol/g to about 6 mmol/g of dry crosslinked arylimidazolium polymer.

In some embodiments, the crosslinked polymer membrane is characterized as a gel.

In some embodiments, the crosslinked polymer membrane is characterized as a solid.

In some embodiments, the crosslinked polymer membrane as described herein is incorporated into a catalyst layer of a fuel cell, of an electrolyzer, or of another electrochemical device.

In some embodiments, an electrochemical device comprising the crosslinked polymer membrane described herein is a fuel cell, an electrolyzer, a redox flow battery, or another electrochemical device.

### Method of Making a Polymer Membrane

In another aspect, the present disclosure provides a method of making a crosslinked polymer membrane, the method comprising:
preparing a casting solution of a plurality of arylimidazolium polymer chains, one or more crosslinker, and one or more solvent, and optionally adding KI, NaI, tetraalkyl ammonium iodide, or a combination thereof;
casting the casting solution onto a supporting substrate to form a film; and
heating the film at a temperature between about 80° C. and about 100° C. to form the crosslinked polymer membrane,
wherein:
the crosslinked polymer membrane comprises a plurality of arylimidazolium polymer chains and a crosslinking moiety, and wherein the arylimidazolium polymer chains are connected to the crosslinking moiety through a covalent bond.

In some embodiments, the arylimidazolium polymer chains are as described herein. In some embodiments, each chain of the plurality of arylimidazolium polymer chains is the same. In some embodiments, each chain of the plurality of arylimidazolium polymer chains is different. In some embodiments, two or more chains are the same and two or more chains are different.

In some embodiments, the arylimidazolium polymer chains of the plurality of arylimidazolium polymer chains comprise a plurality of repeat units. Each repeat unit of the plurality of repeat units is the same, is different, or is a combination thereof. In such embodiments, each repeat unit of the plurality of repeat units is independently selected from Formula (I) as described herein. In some embodiments, each repeat unit of the plurality of repeat units is independently selected from Formula (II) as described herein. In some embodiments, each repeat unit of the plurality of repeat units is independently selected from Formula (III) as described herein. In some embodiments, each repeat unit of the plurality of repeat units is independently selected from Formula (IV) as described herein. In some embodiments, each repeat unit of the plurality of repeat units is independently selected from Formula (V) as described herein. In some embodiments, each repeat unit of the plurality of repeat units is independently selected from Formula (VI) as described herein. In some embodiments, each repeat unit of the plurality of repeat units is independently selected from Formula (VII) as described herein. In some embodiments, each repeat unit of the plurality of repeat units is independently selected from Formula (VIII) as described herein. In some embodiments, each repeat unit of the plurality of repeat units is independently selected from Formula (IX) as described herein.

In some embodiments, each arylimidazolium polymer chain comprises nitrogen atoms. In some embodiments, the nitrogen atoms are alkylated as described herein. In some embodiments, at least about 90% of the nitrogen atoms are alkylated.

In some embodiments, the average molecular weight of the plurality of arylimidazolium polymer chains is as described herein. In some embodiments, the average molecular weight of the plurality of arylimidazolium polymer chains is between about 100 kDa and about 2000 kDa.

In some embodiments, one or more of R₁, R₂, R₃, and R₄ is a crosslinking moiety.

In some embodiments, the one or more crosslinking moiety is covalently bound to a nitrogen atom of a first arylimidazolium polymer chain and a nitrogen atom of a second arylimidazolium polymer chain. In some embodiments, the one or more crosslinking moiety is covalently bound to a first nitrogen atom of an arylimidazolium polymer chain and a second nitrogen atom of the same arylimidazolium polymer chain. In some embodiments, a one or more crosslinking moiety is covalently bound to a nitrogen atom of a first arylimidazolium polymer chain and a nitrogen atom of a second arylimidazolium polymer chain, and a one or more crosslinking moiety is covalently bound to a first nitrogen atom of an arylimidazolium polymer chain and a second nitrogen atom of the same arylimidazolium polymer chain.

The crosslinker may comprise (on average) two reactive groups, although three or more reactive groups are also suitable. For example, the reactive groups on the crosslinker can be halogens. The reactive groups on the crosslinker can be an iodo group. The reactive groups on the crosslinker can be a bromo group. The reactive groups on the crosslinker can be a chloro group. The reactive groups on the crosslinker can be a combination of halogens.

In some embodiments, the method comprises one or more crosslinker, wherein the crosslinker is a substituted or unsubstituted dihaloalkane. In some embodiments, the method comprises one or more crosslinker, wherein the crosslinker is a substituted or unsubstituted 1,3-dibromopropane, a substituted or unsubstituted 1,3-diiodopropane, a substituted or unsubstituted 1,6-dibromohexane, a substituted or unsubstituted 1,6-diiodohexane, a substituted or unsubstituted 1,8-dibromooctane, a substituted or unsubstituted 1,8-diiodooctane, a substituted or unsubstituted 1,10-dibromodecane, a substituted or unsubstituted 1,10-diiododecane, a substituted or unsubstituted 1,12-dibromododecane, a substituted or unsubstituted 1,12-diiodododecane, a substituted or unsubstituted 1,14-dibromotetradecane, a substituted or unsubstituted 1,14-diiodotetradecane, a substituted or unsubstituted 1,4-(bischloromethyl)xylene, or a combination thereof.

In some embodiments, the substituted dihaloalkane is substituted with C₁-C₆ alkyl.

In some embodiments, the substituted 1,3-dibromopropane, 1,3-diiodopropane, 1,6-dibromohexane, 1,6-diiodohexane, 1,8-dibromooctane, 1,8-diiodooctane, 1,10-dibromodecane, 1,10-diiododecane, 1,12-dibromododecane, 1,12-diiodododecane, 1,14-dibromotetradecane, 1,14-diiodotetradecane, and 1,4-(bischloromethyl)xylene, are each independently substituted with C₁-C₆ alkyl.

In some embodiments, the crosslinked polymer membrane comprises a crosslinking moiety as described herein.

In the method, each reactive group of the crosslinker reacts with an imidazole nitrogen atom of an arylimidazolium polymer chain. When one of the reactive groups of a crosslinker reacts with the nitrogen atom, the crosslinker forms a covalent bond with the arylimidazolium polymer chain. When another reactive group of the crosslinker reacts with a nitrogen atom of the same arylimidazolium polymer chain, the crosslinker forms a crosslink between two parts of the arylimidazolium polymer chain through a crosslinking moiety bound by a covalent bond in an intramolecular crosslink. When another reactive group of the crosslinker reacts with a nitrogen atom of a second arylimidazolium polymer chain, the crosslinker forms a crosslink between two arylimidazolium polymer chains through a crosslinking moiety bound by a covalent bond in an intermolecular crosslink. In some embodiments, the crosslinked polymer membrane comprises both intermolecular and intramolecular crosslinks.

In some embodiments, the crosslinking moieties can be the same or can be different. For example, when the method comprises one crosslinker, the crosslinked polymer membrane comprises one, or more than one, of the same crosslinking moiety. In another example, when the method comprises two or more different crosslinkers, the crosslinked polymer membrane comprises two or more different crosslinking moieties. For example, the method can comprise a combination of more than two crosslinkers wherein some crosslinks comprise the same crosslinking moiety, some crosslinks comprise a second crosslinking moiety, some crosslinks comprise a third crosslinking moiety, and so forth, corresponding to the number of different crosslinkers used to form the crosslinked polymer membrane. In some embodiments, the crosslinking moiety is covalently bound to one arylimidazolium polymer chain to form an intramolecular crosslink. In some embodiments, the crosslinking moiety is covalently bound to two arylimidazolium polymer chains to form an intermolecular crosslink.

Multiple crosslinks within an arylimidazolium polymer chain can occur. Multiple crosslinks between arylimidazolium polymer chains can occur, and a network of crosslinked polymer chains may be formed.

The reactive groups of the crosslinker and arylimidazolium polymer chains may be complementary, such that crosslinkers do not react with each other, arylimidazolium polymer chains do not react with each other, and a crosslinker only reacts with an arylimidazolium polymer chain. As the arylimidazolium polymer chains can have a large number of reactive groups, multiple crosslinks between polymers may be formed, and the crosslinker has enabled the formation of a covalently connected network of arylimidazolium polymer chains.

In some embodiments, the extent of crosslinking is as described herein. In some embodiments, about 1% to about 50% of the arylimidazolium polymer chains are crosslinked.

In some embodiments, the method comprises one or more solvents.

In some embodiments, the method comprises one or more solvent, wherein the one or more solvent is a protic solvent having a boiling point of between about 70° C. and about 500° C. at atmospheric pressure. In some embodiments, the method comprises one or more solvent, wherein the one or more solvent is an aprotic solvent having a boiling point of between about 70° C. and about 500° C. at atmospheric pressure. In some embodiments, the method comprises both a protic solvent having a boiling point of between about 70° C. and about 500° C. at atmospheric pressure and an aprotic solvent having a boiling point of between about 70° C. and about 500° C. at atmospheric pressure.

In some embodiments, the method comprises a protic organic solvent having a boiling point of between about 70° C. and about 500° C. at atmospheric pressure. In some embodiments, the method comprises a diprotic organic solvent having a boiling point of between about 100° C. and about 500° C. at atmospheric pressure. In some embodiments, the method comprises an aprotic organic solvent comprising a ketone and having a boiling point of between about 100° C. and about 500° C. at atmospheric pressure. In some embodiments, the method comprises an aprotic organic solvent comprising a carbonate and having a boiling point of between about 100° C. and about 500° C. at atmospheric pressure. In some embodiments, the method comprises a combination of one or more protic organic solvent having a boiling point of between about 70° C. and about 500° C. at atmospheric pressure, a diprotic organic solvent having a boiling point of between about 100° C. and about 500° C. at atmospheric pressure, an aprotic organic solvent comprising a ketone and having a boiling point of between about 100° C. and about 500° C. at atmospheric pressure, and an aprotic organic solvent comprising a carbonate and having a boiling point of between about 100° C. and about 500° C. at atmospheric pressure.

In some embodiments, the method comprises adding KI. In some embodiments, the method comprises adding NaI. In some embodiments, the method comprises adding tetraalkyl ammonium iodide. In some embodiments, the method comprises adding a combination of any of KI, NaI, and tetraalkyl ammonium iodide. In some embodiments, the method lacks KI, NaI, and tetraalkyl ammonium iodide.

In some embodiments, the preparing the casting solution comprises selecting an amount of the plurality of arylimidazolium polymer chains relative to an amount of the one or more crosslinker; selecting the one or more solvent; and mixing the plurality of arylimidazolium polymer chains, the one or more crosslinker, and the one or more solvent.

In some embodiments, the preparing the casting solution comprises selecting an amount of the plurality of arylimidazolium polymer chains relative to an amount of the one or more crosslinker; selecting the one or more solvent; adding KI, NaI, tetraalkyl ammonium iodide, or a combination thereof; and mixing the plurality of arylimidazolium polymer chains, the one or more crosslinker, and the one or more solvent, and the KI, NaI, tetraalkyl ammonium iodide, or a combination thereof.

In some embodiments, the casting solution comprises a ratio of the plurality of arylimidazolium polymer chains to the one or more crosslinker as described herein. In some embodiments, the casting solution comprises a ratio of the plurality of arylimidazolium polymer chains to the one or more crosslinker of about 60:40 to about 95:5. In some embodiments, the casting solution comprises a ratio of the plurality of arylimidazolium polymer chains to the one or more crosslinker of about 75:25 to about 95:5. In some embodiments, the casting solution comprises a ratio of the plurality of arylimidazolium polymer chains to the one or more crosslinker of about 80:20 to about 95:5. In some embodiments, the casting solution comprises a ratio of the plurality of arylimidazolium polymer chains to the one or more crosslinker of about 85:15 to about 95:5. In some embodiments, the casting solution comprises a ratio of the plurality of arylimidazolium polymer chains to the one or more crosslinker of about 88:12 to about 92:8. In some embodiments, the casting solution comprises a ratio of the plurality of arylimidazolium polymer chains to the one or more crosslinker of about 89:11 to about 91:9.

In some embodiments, the casting solution comprises a ratio of the plurality of arylimidazolium polymer chains to the one or more crosslinker of about 90:10.

In some embodiments, the casting solution is cast onto a supporting substrate to form a film. In some embodiments, the film is in a continuous arrangement or in a predetermined pattern.

In some embodiments, the supporting substrate comprises a polymeric film, glass, metal, stiff papers, or a lamination of any of these materials. The supporting substrate can be formed in any suitable shape. In some embodiments, the polymeric film supports comprise poly(ethylene terephthalate), poly(ethylene naphthalate), polycarbonate, polystyrene, cellulose acetate, inorganic polymeric materials such as certain glasses, and the like. In some embodiments, the supporting substrate comprises a polyester film.

The surface of the supporting substrate can be treated to improve adhesion of the crosslinked arylimidazolium polymer or crosslinked polymer membrane disclosed herein. For example, the surface can be treated by corona discharge prior to applying or casting the casting solution. Alternatively, an under-coating or subbing layer, such as a layer formed from a halogenated phenol or a partially hydrolyzed vinyl chloride-vinyl acetate copolymer can be applied to the supporting substrate surface prior to casting the casting solution.

In some embodiments, the casting solution is applied to the support and dried sufficiently to produce a crosslinked polymer membrane having a dry thickness of at least about 10 microns. In some embodiments, the casting solution is applied to the support and dried sufficiently to produce a crosslinked polymer membrane having dry thickness of at least about 25 microns. In some embodiments, the casting solution is applied to the support and dried sufficiently to produce a crosslinked polymer membrane having dry thickness of up to and including about 200 microns. The cast solution can be uniform over the entire substrate surface in a continuous manner. The cast solution can be uniform over the entire substrate surface in a discontinuous manner. The cast solution can be disposed in a random or predetermined pattern.

In some embodiments, the crosslinked polymer membrane has features as described herein.

In some embodiments, the crosslinked polymer membrane has a thickness of up to about 200 μm. In some embodiments, the crosslinked polymer membrane has a thickness of up to about 100 μm. In some embodiments, the crosslinked polymer membrane has a thickness of up to about 80 μm. In some embodiments, the crosslinked polymer membrane has a thickness of up to about 60 μm. In some embodiments, the crosslinked polymer membrane has a thickness of at least about 20 μm. In some embodiments, the crosslinked polymer membrane has a thickness of at least about 40 μm. In some embodiments, the crosslinked polymer membrane has a thickness of between about 20 μm and about 200 μm. In some embodiments, the crosslinked polymer membrane has a thickness of between about 20 μm and about 100 μm. In some embodiments, the crosslinked polymer membrane has a thickness of between about 40 μm and about 80 μm. In some embodiments, the crosslinked polymer membrane has a thickness of between about 40 μm and about 60 μm. In some embodiments, the crosslinked polymer membrane has a thickness of between about 45 μm and about 55 μm. In some embodiments, the crosslinked polymer membrane has a thickness of between about 48 μm and about 52 μm. In some embodiments, the crosslinked polymer membrane has a thickness of between about 49 μm and about 51 μm. In some embodiments, the crosslinked polymer membrane has a thickness of about 50 μm.

In some embodiments, the heating occurs at a temperature between about 80° C. to about 100° C. In some embodiments, the heating occurs at a temperature at least about 80° C. In some embodiments, the heating occurs at a temperature of no more than about 100° C.

In some embodiments, the heating occurs for about 20 to about 180 minutes. In some embodiments, the heating occurs for about 20 to about 90 minutes. In some embodiments, the heating occurs for about 30 to about 60 minutes. In some embodiments, the heating occurs for about 20 to about 40 minutes. In some embodiments, the heating occurs for about 30 minutes. In some embodiments, the heating occurs for at least about 20 minutes. In some embodiments, the heating occurs for at least about 30 minutes. In some embodiments, the heating occurs for about 30 minutes.

Control over properties and performance of the crosslinked membrane of the disclosure may be exerted by choosing the proper ratio between the polymer and crosslinker, as this determines the molar equivalence between the plurality of arylimidazolium polymer chains and one or more crosslinker.

In some embodiments, the crosslinked polymer membrane produced by the method described herein is incorporated into a catalyst layer of a fuel cell, of an electrolyzer, or of another electrochemical device.

In some embodiments, an electrochemical device comprising the crosslinked polymer membrane produced by the method described herein is a fuel cell, an electrolyzer, a redox flow battery, or another electrochemical device.

### EXAMPLES

Arylimidazolium monomers with specified alkyl side chains produce robust, sterically protected poly(arylimidazolium) hydroxide anion exchange polymers that, when crosslinked, possess a combination of high ion-exchange capacity, stability under highly caustic conditions, and exceptional mechanical strength.

### Example 1

### Polymer Synthesis

Various monomers used in the synthesis of the polymers of Formula (I) were prepared and characterized following reported methods (Holdcroft et al, Nature Communications (2019) 10, 2306), herein incorporated by reference in its entirety.

Synthesis of the various poly(bis-arylimidazoliums) of Formula (I) was accomplished via Yamamoto-coupling homo-polymerization of dichloro-imidazole monomers through two approaches: (1) ex situ Ni(COD)₂ (Synthesis I), and (2) in situ generation of Ni(COD)₂ (Synthesis II), to generate polymers having Structure (I).

### Synthesis I—Polymerization Via Ex Situ Ni(COD)₂

Tetramethylated poly(bis-arylimidazolium) (TM-PBAI) was prepared by placing 2,2′-bipyridine (0.075 g, 0.48 mmol) in a 50 mL round-bottom flask, and the reaction flask evacuated and refilled with argon. Ni(COD)₂ (0.132 g, 0.48 mmol, Aldrich) was transferred into the reaction mixture, and the flask was evacuated and purged with argon repeatedly. Anhydrous DMF (5 mL) was added, and the mixture was heated to 80° C. for 30 minutes. In a separate flask, 2,2′-(2,3,5,6-tetramethyl-2-yl)bis(3-methyl-4-chlorophenyl-5-diphenyl-imidazole) (0.1335 g, 0.2 mmol) and 5 mL anhydrous DMF was added. The flask was purged with argon, and after the catalyst was heated for 30 minutes, the monomer solution was transferred into the catalyst solution. The resulting mixture was heated at 80° C. while stirring for 20 h. After cooling, the solution was poured into 200 mL of 6 M HCl, to consume the catalyst. The solid was filtered and washed with water, aqueous sodium bicarbonate, and acetone. After drying in vacuo, the solid was dissolved in 5 mL DCM and 5 mL DMSO. 20 equivalents of Mel was added, and the solution heated to 80° C. for three days. The polymer was precipitated in 100 mL ethyl acetate, washed with acetone, and filtered to yield a brown solid 0.1695 g (100% yield).

The polymers obtained following the aforementioned method had a medium range molecular weight (MW=140 kDa, Polydispersity Index=1.70), as reported by Holdcroft et al in Nature Communications (2019) 10, 2306.

The polymer having Structure (IX) was obtained by the foregoing method:

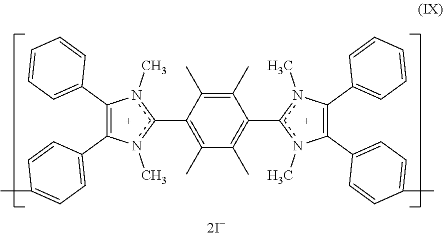

### Synthesis II—Polymerization Via In Situ Ni(COD)₂

Synthesis of various poly(arylimidazoliums) has been accomplished via Yamamoto-coupling homo-polymerization of dichloro-imidazole monomers to obtain high molecular weight (MW=500-2000 kDa, Polydispersity Index=2-4) poly(bis-arylimidazoles) using in-situ generated bis(cyclooctadiene)nickel(0) (Ni(COD)₂).

A 5-L round-bottom flask equipped with a rubber septum was charged, under a stream of argon (or nitrogen), with anhydrous Ni(acac)₂ (154.2 g) and 1,5-cyclooctadiene (380 mL). This solution was stirred and cooled to 0° C., upon which 1.0 M diisobutylaluminum hydride (DIBAL-H) in hexanes (1.21 L) was added slowly, keeping the temperature at 0° C. during the addition. After the addition was complete, the stirring of the brownish-yellow solution was allowed to continue for 2 h at 0° C. During this time period, yellow-orange crystals of Ni(COD)₂ were observed to precipitate. The stirring was stopped, and the crystals allowed to settle. Keeping the flask as close to 0° C. as possible, the solution was carefully decanted under argon or nitrogen to remove it while leaving the crystals of Ni(COD)₂ behind. Once the solution was removed, the crystals were washed twice with cold (2-5° C.) anhydrous diethyl ether (0.6 L each time) or anhydrous hexanes, and the solution removed again by decantation.

To the crystals were added 2,2′-bipyridine (100 g) and 2,2′-(2,3,5,6-tetramethyl-2-yl)bis(3-methyl-4-chlorophenyl-5-diphenyl-imidazole) (80 g). To this mixture, 2.6 L of anhydrous DMF was added by syringe or cannula through the septum, and the mixture was heated at 60° C. for 2 h after which the original purple color of the solution had diminished. Argon (or nitrogen) purging was terminated but the flask remained sealed.

To accomplish quaternization of imidazole polymer, alkyl iodide (such as 1-iodobutane, 350 g) was added into the reaction flask. Stirring of the reaction mixture was maintained at 110° C. for 18 h. The reaction mixture was cooled down to 40-50° C., and 0.24 L of concentrated HCl (˜36%) was added gradually (to prevent precipitation of polymer at this stage). The mixture was stirred until all the black “Ni” was reacted and the solution turned into a clear greenish blue color. The polymer was then precipitated in 13 L of water. The off-white product was filtered, and washed with water until the filtrate pH was at 7.0. The polymer was collected and dried in an oven overnight at 100° C.

The degree of alkylation in polymers was determined by integration of representative peaks of said polymer of (a) R₁, R₂, R₃, R₄=Me, wherein the degree of functionality was calculated based on the ratio between N—CH₃ protons out of possible 12 (6=3-4 ppm) when aromatic protons are fixed at 18 (6=7.0-8.1 ppm), and (b) R₁, R₂, R₃, R₄=a combination of two methyl and two butyl groups, wherein the degree of functionality was calculated based on the ratio between butyl CH₃ protons out of possible 6 (6=0.5-0.7 ppm) when aromatic protons were fixed at 18 (6=7.0-8.1 ppm).

### Example 2

### Crosslinked Membrane Synthesis: General Method

A coating formulation was prepared by dissolving PBI (average molecular weight, about 130 kDa) (typically 1 g) in 10 mL DMF and adding crosslinker 1,6-Diiodohexane (typically 0.2-0.4 g), followed by thorough mixing by stirring. The resulting composition was then cast, using a polymer casting table equipped with drawing knife, onto a PET substrate to obtain a film (typical thickness of 30-50 microns). The film was dried in an oven (at 80° C.) for 2 min, followed by heating at 90-100° C. for 45-60 min.

To establish the effectiveness of PBI film cross-linking, PBI film (with a size of 1×3 cm and typical thickness of 50 microns) was placed in a glass vial with an appropriate amount of methanol and acetone solvent (1:1 ratio, typically 5 mL total volume). Cross-linking of PBI films was identified as having occurred when the film did not dissolve upon standing in this solution for 24 h.

Various PBI films comprising varying amounts of 1,6-diiodohexane were cast and annealed at 100° C. for 1-24 h. Pieces of the cast and cured films, 1×3 cm, were soaked in a methanol/acetone mixture (5 mL total of solvent mix) for 24 h to multiple days. The film insolubility (or solubility) in the solvent mixture was used to ascertain the efficiency of cross-linking.

TABLE 1
Effect of Cure Time and wt % Diiodohexane
Crosslinker on Membrane Crosslinking

| | | | | Film | | |
|---|---|---|---|---|---|---|
| | | | | Dissolution | | |
| | | | | Test (1:1 | | |
| | | | Crosslinker | MeOH- | | |
| | Degree of | | wt % (mass) | Acetone | | |
| Polymer | alkylation | Polymer | with respect | Solvent | | Membrane |
| type | (%) | amount | to polymer | Mixture) | | Crosslinked? |
| R₁, R₂ = | 98.0 | 1 g | 16.6 (0.2 g) | 24 | hours | Yes |
| methyl | | | | | | |
| R₃, R₄ = | | | | | | |
| butyl | | | | | | |
| R₁, R₂ = | 97.8 | 1 g | 16.6 (0.2 g) | 3 | days | Yes |
| methyl | | | | | | |
| R₃, R₄ = | | | | | | |
| butyl | | | | | | |
| R₁, R₂ = | 91.6 | 1 g | 28.6 (0.4 g) | 5 | days | Yes |
| methyl | | | | | | |
| R₃, R₄ = | | | | | | |
| butyl | | | | | | |
| R₁, R₂ = | 91.6 | 1 g | 23 (0.3 g) | 5 | days | Yes |
| methyl | | | | | | |
| R₃, R₄ = | | | | | | |
| butyl | | | | | | |
| R₁, R₂ = | 91.6 | 1 g | 16.6 (0.2 g) | 5 | days | Yes |
| methyl | | | | | | |
| R₃, R₄ = | | | | | | |
| butyl | | | | | | |
| R₁, R₂ = | 91.6 | 1 g | 9.1 (0.1 g) | 6 | hours | No |
| methyl | | | | | | |
| R₃, R₄ = | | | | | | |
| butyl | | | | | | |
| R₁, R₂ = | 91.6 | 1 g | 5.7 (0.06 g) | 1 | hour | No |
| methyl | | | | | | |
| R₃, R₄ = | | | | | | |

butyl

Data presented in Table 1 shows a crosslinker weight percent of greater than 9.1, with regard to the polymer, is required to achieve good crosslinking of a membrane, as judged by film dissolution in 1:1 methanol/acetone mixture.

### Example 3

### Crosslinked Membrane Synthesis: Effect of Added Iodide Salt

The effect of added iodide salt on crosslinking efficiency was evaluated by conducting crosslinking with and without added iodide salt.

A coating formulation was prepared by dissolving PBI (average molecular weight, about 130 kDa) (typically 1 g) in DMF (10 mL) and adding 1,4 bis(chloromethyl)benzene (BCB) crosslinker (10 wt % with respect to polymer), and thoroughly mixing by stirring. The resulting composition was then blade coated, using a polymer casting table equipped with a drawing knife, onto a PET substrate to obtain a film (typical thickness of 30-50 microns). The film was dried in an oven (at 80° C.) for 2 min, followed by heating at 90-100° C. for 45-60 min.

Similarly, a coating formulation supplemented with iodide salt was prepared by dissolving PBI (average molecular weight, about 130 kDa) (typically 1 g) in DMF (10 mL), adding crosslinker (10 wt % with respect to polymer) and NaI (10 wt % w.r.t. polymer), and mixing thoroughly by stirring. The resulting composition was then blade coated onto a PET substrate to obtain a film (typical thickness of 30-50 microns). The film was dried in an oven (at 80° C.) for 2 min, followed by heating at 90-100° C. for 45-60 min.

Effectiveness of PBI film cross-linking, (1×3 cm with typical thickness of 50 microns) was assessed by placing the PBI film in a glass vial containing an appropriate amount of 1:1 MeOH/Acetone solvent mixture (typically 5-10 mL total volume). Cross-linking of PBJ films was identified as having occurred when the film did not dissolve upon standing in 1:1 MeOH/Acetone mixture for 24 h.

Results and effect of added NaI on crosslinking efficiency are shown in Table 2

TABLE 2
Effect of Added Iodide Catalyst on Crosslinking

| | | | | Film | | |
|---|---|---|---|---|---|---|
| | | | | Dissolution | | |
| | | | | Test in (1:1 | | |
| | | | Cross- | MeOH- | | |
| | Degree of | | linker | Acetone | | Membrane |
| Polymer | alkylation | Polymer | and wt % | Solvent | NaI | Cross- |
| type | (%) | amount | amount | Mixture | wt % | linked? |
| R1, R2 = | 97 | 1 g | BCB, | 24 hours | 0 | No |
| methyl | | | 10 wt % | | | |
| R3, R4 = | | | | | | |
| butyl | | | | | | |
| R1, R2 = | 97 | 1 g | BCB, | 24 hours | 10 | Yes |
| methyl | | | 10 wt % | | wt % | |
| R3, R4 = | | | | | | |
| butyl | | | | | | |

Data in Table 2 shows added iodide salt positively effects crosslinking. Addition of BCB followed by heating did not result in crosslinking of the membrane, but efficient crosslinking of the membrane occurred upon addition of NaI.

### Example 4

### Comparison of Mechanical Properties of Crosslinked and Non-Crosslinked Membranes

Samples of crosslinked and non-crosslinked membranes were subjected to a tensile strength test, using an Instron 3345 single-column tester, indicating within experimental errors that the membrane mechanical properties were not negatively impacted by cross linking (Table 3).

TABLE 3
Mechanical properties of crosslinked and non-crosslinked membranes

| | Degree of alkylation | Stress | Strain | Elastic | |
|---|---|---|---|---|---|
| Polymer type | (%) | (mPa) | (%) | Modulus | Toughness |
| Non-Crosslinked | 96 | 91.7 | 53.3 | 1348 | 34.4 |
| R1, R2 = methyl | | | | | |
| R3, R4 = butyl | | | | | |
| Crosslinked | >96 | 79.6 | 40.8 | 1369 | 24.4 |
| R1, R2 = methyl | | | | | |
| R3, R4 = butyl | | | | | |

### Example 5

### Comparison of Ionic Conductivities of Crosslinked and Non-Crosslinked Membranes

In-plane conductivity of a series of membranes was measured using a Solartron SI 1260 impedance/gain-phase analyzer. Conductivities were compared with respect to a non-crosslinked membrane, where a gradual decrease in conductivity occurred due to reduction of the polymer wt % and the ionic sites (Table 4).

TABLE 4
Effect of Crosslinking on Ionic Conductivity of Membranes

| | | Crosslinker | | |
|---|---|---|---|---|
| | Degree of alkylation | amount | Conductivity | Water uptake |
| Polymer type | (%) | (wt %) | (mS/cm) | (wt %) |
| Non-Crosslinked | 96 | 0 | 6.4 | 15 |
| R1, R2 = methyl | | | | |
| R3, R4 = butyl | | | | |
| Crosslinked | >96 | 10 | 4.3 | 11.5 |
| R1, R2 = methyl | | | | |
| R3, R4 = butyl | | | | |
| Crosslinked | >96 | 20 | 4.46 | 8.8 |
| R1, R2 = methyl | | | | |
| R3, R4 = butyl | | | | |
| Crosslinked | >96 | 30 | 4.61 | 7.2 |
| R1, R2 = methyl | | | | |
| R3, R4 = butyl | | | | |
| Crosslinked | >96 | 40 | 3.56 | 4.6 |
| R1, R2 = methyl | | | | |
| R3, R4 = butyl | | | | |

The terminology used in the description of the invention herein is for the purpose of describing particular embodiments only and is not intended to be limiting of the invention. All publications, patent applications, patents and other references mentioned herein are incorporated by reference in their entirety. In case of a conflict in terminology, the present specification is controlling.

While illustrative embodiments have been illustrated and described, it will be appreciated that various changes can be made therein without departing from the spirit and scope of the invention.

### EMBODIMENTS

Embodiment 1. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (I):

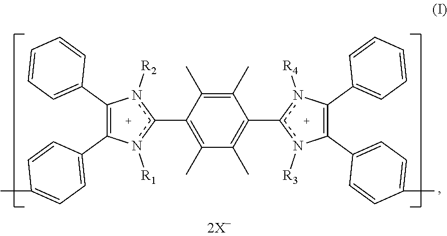

wherein:
R₁, R₂, R₃, and R₄ are each independently selected from C₁₋₈ alkyl and a crosslinking moiety, and
the crosslinked polymer membrane comprises about 90 wt % of the arylimidazolium polymer chains, and about 10 wt % of the one or more crosslinking moiety.

Embodiment 2. The crosslinked polymer membrane of Embodiment 1, wherein R₁, R₂, R₃, and R₄ are the same C₁₋₈ alkyl.

Embodiment 3. The crosslinked polymer membrane of Embodiment 1, wherein two of R₁, R₂, R₃, and R₄ are different from two of R₁, R₂, R₃, and R₄.

Embodiment 4. The crosslinked polymer membrane of Embodiments 1 or 3, wherein R₁ is different from R₂, and R₃ is different from R₄.

Embodiment 5. The crosslinked polymer membrane of any one of Embodiments 1-4, wherein one or more of R₁ and R₂ is methyl, and one or more of R₃ and R₄ is methyl.

Embodiment 6. The crosslinked polymer membrane of any one of Embodiments 1-5, wherein one or more of R₁ and R₂ is C₂₋₆ alkyl, and one or more of R₃ and R₄ is C₂₋₆ alkyl.

Embodiment 7. The crosslinked polymer membrane of any one of Embodiments 1 or 3-6, wherein one of R₁ and R₂ is n-butyl, and one of R₃ and R₄ is n-butyl.

Embodiment 8. The crosslinked polymer membrane of any one of Embodiments 1 or 3-7, wherein one of R₁ and R₂ is methyl, one of R₁ and R₂ is n-butyl, one of R₃ and R₄ is methyl, and one of R₃ and R₄ is n-butyl.

Embodiment 9. The crosslinked polymer membrane of any one of Embodiments 1 or 3-8, wherein the repeat unit has a structure of Formula (II):

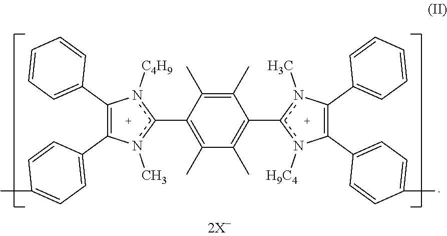

Embodiment 10. The crosslinked polymer membrane of any one of Embodiments 1 or 3-9, wherein the repeat unit has a structure of Formula (III):

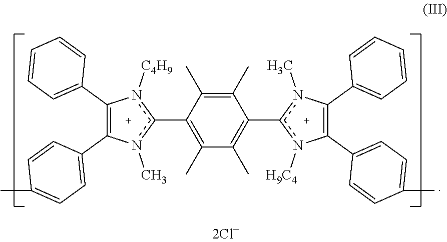

Embodiment 11. The crosslinked polymer membrane of any one of Embodiments 1-10, wherein one or more of R₁, R₂, R₃, and R₄ is a crosslinking moiety.

Embodiment 12. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (IV):

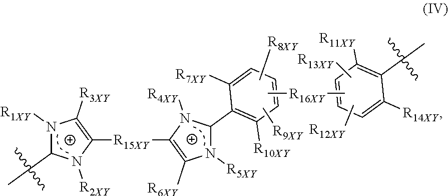

wherein R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
   at least one of R_{1XY} and R_{2XY} is selected from alkyl, perfluoroalkyl, heteroalkyl, aryl, and aralkyl,
   when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
   at least one of R_{4XY} and R_{5XY} is selected from alkyl, perfluoroalkyl, heteroalkyl, aryl, and aralkyl, and
   when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{15XY} is selected from alkylene, perfluoroalkylene, heteroalkylene, arylene, aralkylene, and heteroarylene, each optionally substituted with 1, 2, 3, or 4 substituents independently selected from alkyl, perfluoroalkyl, heteroalkyl, and halo;
R_{16XY} is selected from a bond, arylene, and heteroarylene, wherein said arylene and heteroarylene is each optionally substituted with 1, 2, 3, or 4 substituents independently selected from alkyl, perfluoroalkyl, heteroalkyl, and halo;
R_{7XY}, R_{10XY}, R_{11XY}, and R_{14XY} are each independently selected from H, alkyl, perfluoroalkyl, and heteroalkyl; and
R_{8XY}, R_{9XY}, R_{12XY} and R_{13XY} are each independently selected from hydrogen (H), alkyl, perfluoroalkyl, and heteroalkyl.

Embodiment 13. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (V):

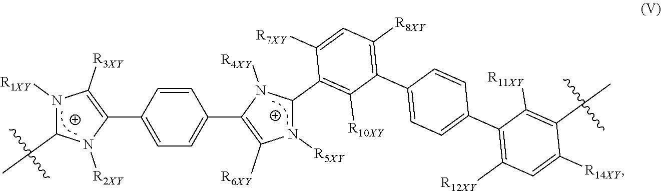

wherein:
R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
   at least one of R_{1XY} and R_{2XY} is selected from alkyl, perfluoroalkyl, heteroalkyl, aryl, and aralkyl,
   when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
   at least one of R_{4XY} and R_{5XY} is selected from alkyl, perfluoroalkyl, heteroalkyl, aryl, and aralkyl, and
   when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{7XY}, R_{10XY}, R_{11XY}, and R_{14XY} are each independently selected from H, alkyl, perfluoroalkyl, and heteroalkyl; and
R_{8XY} and R_{12XY} are each independently selected from hydrogen (H), alkyl, perfluoroalkyl, and heteroalkyl.

Embodiment 14. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (VI):

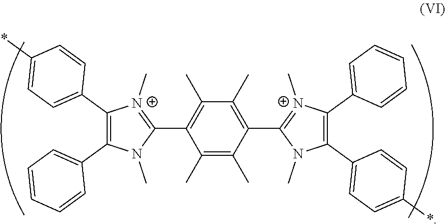

Embodiment 15. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (VII):

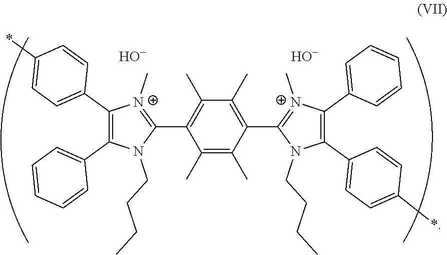

Embodiment 16. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (VIII):

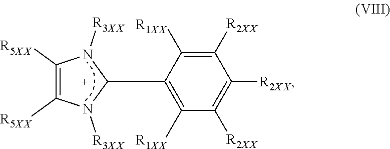

wherein:
R_{1XX} is independently selected from the group consisting of H, methyl, trifluoromethyl, alkyl, perfluoroalkyl, heteroalkyl, alkoxy, perfluoroalkoxy, halo, aryl, heteroaryl group, a crosslinking moiety, and a polymer chain;
R_{2XX} is independently selected from the group consisting of hydrogen, any group, and a polymer chain;
R_{3XX} is independently selected from the group consisting of methyl, trifluoromethyl, alkyl, perfluoroalkyl, heteroalkyl, aryl, alkyl, a polymer chain, and absent; and
R_{5XX} is independently selected from the group consisting of hydrogen, any group, and a polymer chain; and
wherein at least one of R_{1XX}, R_{2XX}, R_{3XX}, and R_{5XX}, is a polymer chain.

Embodiment 17. The crosslinked polymer membrane of any one of Embodiments 1-16, wherein X is selected from the group consisting of F⁻, Cl⁻, Br⁻, I⁻, HO⁻, BF₄⁻, PF₆⁻, HCO₃⁻, CH₃CO₂⁻, CH₃SO₃⁻, C₂H₅SO₃⁻, CH₃C₆H₄SO₃⁻, NO₃⁻, and a combination thereof.

Embodiment 18. The crosslinked polymer membrane of any one of Embodiments 1-17, wherein X⁻ is Cl⁻, I⁻, or a combination thereof.

Embodiment 19. The crosslinked polymer membrane of any one of Embodiments 1-18, wherein X⁻ is NO₃⁻, I⁻, or a combination thereof.

Embodiment 20. The crosslinked polymer membrane of any one of Embodiments 1-19, wherein each chain of the plurality of arylimidazolium polymer chains is the same, each chain of the plurality of arylimidazolium polymer chains is different, or wherein two or more chains are the same and two or more chains are different.

Embodiment 21. The crosslinked polymer membrane of any one of Embodiments 1-20, wherein each arylimidazolium polymer chain comprises repeat units which are essentially the same, are different, or wherein two or more repeat units are the same and two or more repeat units are different.

Embodiment 22. The crosslinked polymer membrane of any one of Embodiments 1-21, wherein the arylimidazolium polymer chain comprises nitrogen atoms, and at least about 90% of the nitrogen atoms are alkylated.

Embodiment 23. The crosslinked polymer membrane of Embodiment 22, wherein about 91% to about 99% of the nitrogen atoms are alkylated.

Embodiment 24. The crosslinked polymer membrane of Embodiment 22 or 23, wherein at least about 45% of the nitrogen atoms are methylated and at least about 45% of the nitrogen atoms are butylated.

Embodiment 25. The crosslinked polymer membrane of any one of Embodiments 1-24, wherein the one or more crosslinking moiety is covalently bound to one or more arylimidazolium polymer chain.

Embodiment 26. The crosslinked polymer membrane of any one of Embodiments 1-25, wherein the one or more crosslinking moiety is covalently bound to a nitrogen atom of a first arylimidazolium polymer chain, and a nitrogen atom of a second arylimidazolium polymer chain; the one or more crosslinking moiety is covalently bound to a first nitrogen atom of a arylimidazolium polymer chain, and a second nitrogen atom of the same arylimidazolium polymer chain; or a combination thereof.

Embodiment 27. The crosslinked polymer membrane of any one of Embodiments 1-26, wherein the one or more crosslinking moiety is a substituted or unsubstituted 1,3-propane, a substituted or unsubstituted 1,6-hexane, a substituted or unsubstituted 1,8-octane, a substituted or unsubstituted 1,10-decane, a substituted or unsubstituted 1,12-dodecane, a substituted or unsubstituted 1,14-tetradecane, a substituted or unsubstituted α,α′-p-xylene, or a combination thereof, and
wherein the substituted 1,3-propane, 1,6-hexane, 1,8-octane, 1,10-decane, 1,12-dodecane, 1,14-tetradecane, and α,α′-p-xylene are substituted with C₁-C₆ alkyl.

Embodiment 28. The crosslinked polymer membrane of Embodiment 27, wherein the one or more crosslinking moiety is a 1,6-hexane, a 1,8-octane, or a combination thereof.

Embodiment 29. The crosslinked polymer membrane of any one of Embodiments 1-28, wherein about 1% to about 50% of the arylimidazolium polymer chains are crosslinked.

Embodiment 30. The crosslinked polymer membrane of any one of Embodiments 1-29, wherein the crosslinked polymer membrane has a thickness of up to about 200 μm.

Embodiment 31. The crosslinked polymer membrane of any one of Embodiments 1-30, wherein the crosslinked polymer membrane has a concentration of ion exchange groups between about 0.2 mmol/g to about 6 mmol/g of dry crosslinked arylimidazolium polymer.

Embodiment 32. The crosslinked polymer membrane of any one of Embodiments 1-31, wherein an average molecular weight of the plurality of arylimidazolium polymer chains is between about 100 kDa and about 2000 kDa.

Embodiment 33. The crosslinked polymer membrane of any one of Embodiments 1-32, wherein the crosslinked polymer membrane is characterized as a gel.

Embodiment 34. The crosslinked polymer membrane of any one of Embodiments 1-33, wherein the crosslinked polymer membrane is characterized as a solid.

Embodiment 35. A method of making a crosslinked polymer membrane, comprising:
preparing a casting solution of a plurality of arylimidazolium polymer chains, one or more crosslinker, and one or more solvent, and optionally adding KI, NaI, tetraalkyl ammonium iodide, or a combination thereof;
casting the casting solution onto a supporting substrate to form a film; and
heating the film at a temperature between about 80° C. and about 100° C. to form the crosslinked polymer membrane,
wherein:
the crosslinked polymer membrane comprises a plurality of arylimidazolium polymer chains and a crosslinking moiety, and wherein the arylimidazolium polymer chains are connected to the crosslinking moiety through a covalent bond.

Embodiment 36. The method of Embodiment 35, wherein the arylimidazolium polymer chains comprise a plurality of repeat units, which are the same or are different, and which are each independently selected from Formula (I):

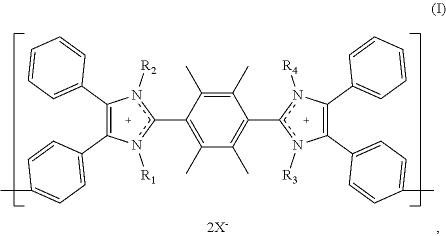

wherein R₁, R₂, R₃, and R₄ are each independently selected from C₁₋₈ alkyl and a crosslinking moiety.

Embodiment 37. The method of Embodiment 36, wherein R₁, R₂, R₃, and R₄ are the same C₁₋₈ alkyl.

Embodiment 38. The method of Embodiment 36, wherein R₁ is different from R₂, and R₃ is different from R₄.

Embodiment 39. The method of any one of Embodiments 36-38, wherein one or more of R₁ and R₂ is methyl, and one or more of R₃ and R₄ is methyl.

Embodiment 40. The method of any one of Embodiments 36-38, wherein one or more of R₁ and R₂ is C₂₋₆ alkyl, and one or more of R₃ and R₄ is C₂₋₆ alkyl.

Embodiment 41. The method of any one of Embodiments 36, or 38-40, wherein the repeat unit comprises a structure of Formula (II):

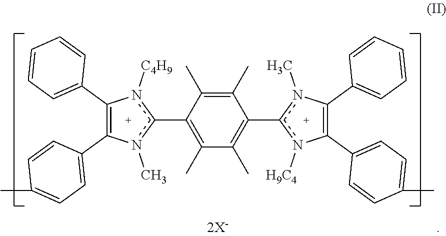

Embodiment 42. The method of any one of Embodiments 36-41, wherein one or more of R₁, R₂, R₃, and R₄ is a crosslinking moiety.

Embodiment 43. The method of Embodiment 35, wherein the arylimidazolium polymer chains comprise a plurality of repeat units, which are the same or are different, and which are each independently selected from Formula (IV):

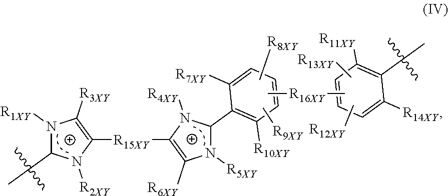

wherein R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
   at least one of R_{1XY} and R_{2XY} is selected from alkyl, perfluoroalkyl, heteroalkyl, aryl, and aralkyl,
   when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
   at least one of R_{4XY} and R_{5XY} is selected from alkyl, perfluoroalkyl, heteroalkyl, aryl, and aralkyl, and
   when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{15XY} is selected from alkylene, perfluoroalkylene, heteroalkylene, arylene, aralkylene, and heteroarylene, each optionally substituted with 1, 2, 3, or 4 substituents independently selected from alkyl, perfluoroalkyl, heteroalkyl, and halo;
R_{16XY} is selected from a bond, arylene, and heteroarylene, wherein said arylene and heteroarylene is each optionally substituted with 1, 2, 3, or 4 substituents independently selected from alkyl, perfluoroalkyl, heteroalkyl, and halo;
R_{7XY}, R_{10XY}, R_{11XY}, and R_{14XY} are each independently selected from H, alkyl, perfluoroalkyl, and heteroalkyl; and
R_{8XY}, R_{9XY}, R_{12XY}, and R_{13XY} are each independently selected from hydrogen (H), alkyl, perfluoroalkyl, and heteroalkyl.

Embodiment 44. The method of Embodiment 35, wherein the arylimidazolium polymer chains comprise a plurality of repeat units, which are the same or are different, and which are each independently selected from Formula (V):

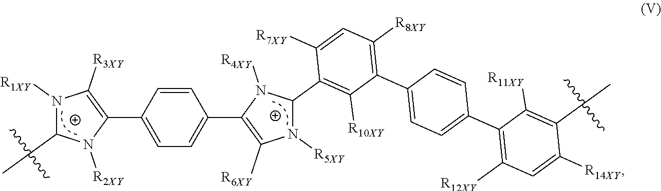

wherein:
R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
   at least one of R_{1XY} and R_{2XY} is selected from alkyl, perfluoroalkyl, heteroalkyl, aryl, and aralkyl,
   when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
   at least one of R_{4XY} and R_{5XY} is selected from alkyl, perfluoroalkyl, heteroalkyl, aryl, and aralkyl, and
   when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{7XY}, R_{10XY}, R_{11XY}, and R_{14XY} are each independently selected from H, alkyl, perfluoroalkyl, and heteroalkyl; and
R_{8XY} and R_{12XY} are each independently selected from hydrogen (H), alkyl, perfluoroalkyl, and heteroalkyl.

Embodiment 45. The method of Embodiment 35, wherein the arylimidazolium polymer chains comprise a plurality of repeat units, which are the same or are different, and which are each independently selected from Formula (VI):

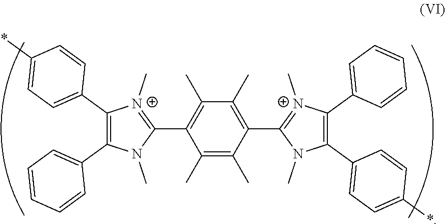

Embodiment 46. The method of Embodiment 35, wherein the arylimidazolium polymer chains comprise a plurality of repeat units, which are the same or are different, and which are each independently selected from Formula (VII):

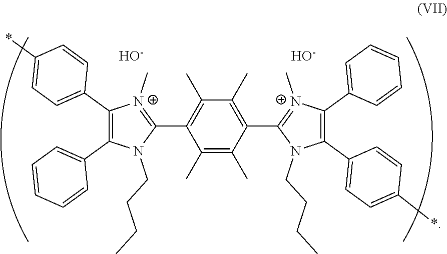

Embodiment 47. The method of Embodiment 35, wherein the arylimidazolium polymer chains comprise a plurality of repeat units, which are the same or are different, and which are each independently selected from Formula (VIII):

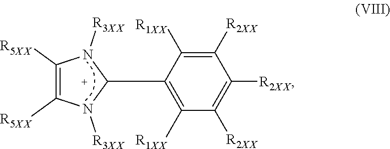

wherein:
R_{1XX} is independently selected from the group consisting of H, methyl, trifluoromethyl, alkyl, perfluoroalkyl, heteroalkyl, alkoxy, perfluoroalkoxy, halo, aryl, heteroaryl group, a crosslinking moiety, and a polymer chain;
R_{2XX} is independently selected from the group consisting of hydrogen, any group, and a polymer chain;
R_{3XX} is independently selected from the group consisting of methyl, trifluoromethyl, alkyl, perfluoroalkyl, heteroalkyl, aryl, alkyl, a polymer chain, and absent; and
R_{5XX} is independently selected from the group consisting of hydrogen, any group, and a polymer chain; and
wherein at least one of R_{1XX}, R_{2XX}, R_{3XX}, and R_{5XX}, is a polymer chain.

Embodiment 48. The method of any one of Embodiments 36-47, wherein X is selected from the group consisting of F⁻, Cl⁻, Br⁻, I⁻, HO⁻, BF₄⁻, PF₆⁻, HCO₃⁻, CH₃CO₂⁻, CH₃SO₃⁻, C₂H₅SO₃⁻, CH₃C₆H₄SO₃⁻, NO₃⁻, and combinations thereof.

Embodiment 49. The method of any one of Embodiments 35-48, wherein each chain of the plurality of arylimidazolium polymer chains is the same, each chain of the plurality of arylimidazolium polymer chains is different, or wherein two or more chains are the same and two or more chains are different.

Embodiment 50. The method of any one of Embodiments 35-49, wherein the arylimidazolium polymer chain comprises nitrogen atoms, and at least about 90% of the nitrogen atoms are alkylated.

Embodiment 51. The method of any one of Embodiments 35-50, wherein the one or more crosslinking moiety is covalently bound to a nitrogen atom of a first arylimidazolium polymer chain, and a nitrogen atom of a second arylimidazolium polymer chain; the one or more crosslinking moiety is covalently bound to a first nitrogen atom of a arylimidazolium polymer chain, and a second nitrogen atom of the same arylimidazolium polymer chain; or a combination thereof.

Embodiment 52. The method of any one of Embodiments 35-51, wherein the one or more crosslinker is a substituted or unsubstituted 1,3-dibromopropane, a substituted or unsubstituted 1,3-diiodopropane, a substituted or unsubstituted 1,6-dibromohexane, a substituted or unsubstituted 1,6-diiodohexane, a substituted or unsubstituted 1,8-dibromooctane, a substituted or unsubstituted 1,8-diiodooctane, a substituted or unsubstituted 1,10-dibromodecane, a substituted or unsubstituted 1,10-diiododecane, a substituted or unsubstituted 1,12-dibromododecane, a substituted or unsubstituted 1,12-diiodododecane, a substituted or unsubstituted 1,14-dibromotetradecane, a substituted or unsubstituted 1,14-diiodotetradecane, a substituted or unsubstituted 1,4-(bischloromethyl)xylene, or a combination thereof,
wherein the substituted 1,3-dibromopropane, 1,3-diiodopropane, 1,6-dibromohexane, 1,6-diiodohexane, 1,8-dibromooctane, 1,8-diiodooctane, 1,10-dibromodecane, 1,10-diiododecane, 1,12-dibromododecane, 1,12-diiodododecane, 1,14-dibromotetradecane, 1,14-diiodotetradecane, and 1,4-(bischloromethyl)xylene, are each independently substituted with C₁-C₆ alkyl.

Embodiment 53. The method of any one of Embodiments 35-52, wherein an average molecular weight of each chain of the plurality of arylimidazolium polymer chains is between about 100 kDa and about 2000 kDa.

Embodiment 54. The method of any one of Embodiments 35-53, wherein about 1% to about 50% of the arylimidazolium polymer chains are crosslinked.

Embodiment 55. The method of any one of Embodiments 35-54, wherein the one or more solvent is one or more protic or aprotic solvent having a boiling point of between about 70° C. and about 500° C. at atmospheric pressure.

Embodiment 56. The method of any one of Embodiments 35-55, wherein the casting solution comprises a ratio of the plurality of arylimidazolium polymer chains to the one or more crosslinker of about 60:40 to about 95:5.

Embodiment 57. The method of any one of Embodiments 35-56, wherein the casting solution comprises a ratio of the plurality of arylimidazolium polymer chains to the one or more crosslinker of about 90:10.

Embodiment 58. The method of any one of Embodiments 35-57, wherein the preparing the casting solution comprises selecting an amount of the plurality of arylimidazolium polymer chains relative to an amount of the one or more crosslinker; selecting the one or more solvent; optionally adding KI, NaI, tetraalkyl ammonium iodide, or a combination thereof; and mixing the plurality of arylimidazolium polymer chains, the one or more crosslinker, and the one or more solvent, and the optionally added KI, NaI, tetraalkyl ammonium iodide, or a combination thereof.

Embodiment 59. The method of any one of Embodiments 35-58, wherein the heating occurs for about 30 minutes.

Embodiment 60. The method of any one of Embodiments 35-59, wherein the crosslinked polymer membrane has a thickness of up to about 200 μm.

Embodiment 61. The crosslinked polymer membrane of any one of Embodiments 1-34, or the crosslinked polymer membrane produced by the method of any one of Embodiments 34-59, incorporated into a catalyst layer of a fuel cell, of an electrolyzer, or of another electrochemical device.

Embodiment 62. An electrochemical device comprising the crosslinked polymer membrane of any one of Embodiments 1-34, or the crosslinked polymer membrane produced by the method of any one of Embodiments 35-60, wherein the electrochemical device is a fuel cell, an electrolyzer, a redox flow battery, or another electrochemical device.

1. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (I): 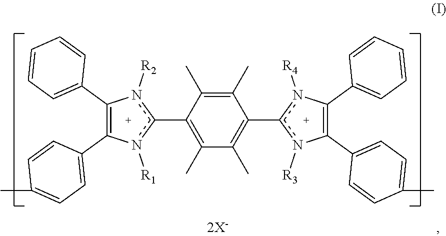
wherein:
R₁, R₂, R₃, and R₄ are each independently selected from C₁₋₈ alkyl and a crosslinking moiety, and
the crosslinked polymer membrane comprises about 90 wt % of the arylimidazolium polymer chains, and about 10 wt % of the one or more crosslinking moiety.

2.-4. (canceled)

5. The crosslinked polymer membrane of claim 1, wherein one or more of R₁ and R₂ is methyl, and one or more of R₃ and R₄ is methyl.

6. The crosslinked polymer membrane of claim 1, wherein one or more of R₁ and R₂ is C₂₋₆ alkyl, and one or more of R₃ and R₄ is C₂₋₆ alkyl.

7. (canceled)

8. The crosslinked polymer membrane of claim 1, wherein one of R₁ and R₂ is methyl, one of R₁ and R₂ is n-butyl, one of R₃ and R₄ is methyl, and one of R₃ and R₄ is n-butyl.

9. The crosslinked polymer membrane of claim 1, wherein the repeat unit has a structure of Formula (II):

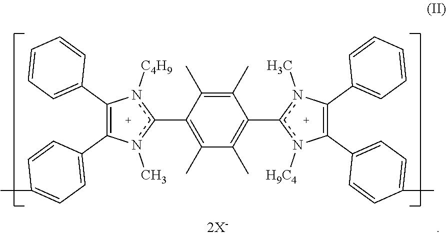

10. The crosslinked polymer membrane of claim 1, wherein the repeat unit has a structure of Formula (III):

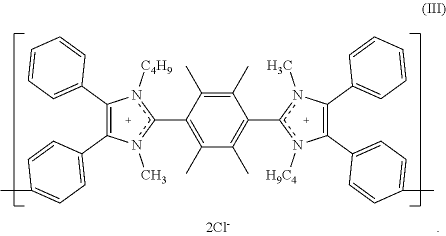

11. The crosslinked polymer membrane of claim 1, wherein one or more of R₁, R₂, R₃, and R₄ is a crosslinking moiety.

12. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (IV): 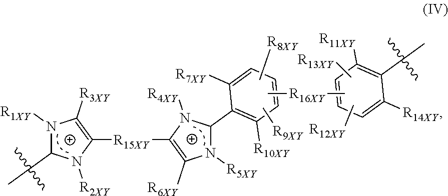
wherein R_{1XY}, R_{2XY}, R_{4XY}, and R_{5XY} are each independently selected from absent, alkyl, perfluoroalkyl, heteroalkyl, aryl, aralkyl, and a crosslinking moiety,
provided that:
at least one of R_{1XY} and R_{2XY} is selected from alkyl, perfluoroalkyl, heteroalkyl, aryl, and aralkyl,
when one of R_{1XY} and R_{2XY} is absent, the imidazolyl group to which the absent R_{1XY} or R_{2XY} is connected (i.e., the imidazolyl group having one of R_{1XY} or R_{2XY}, but not the other) is neutral,
at least one of R_{4XY} and R_{5XY} is selected from alkyl, perfluoroalkyl, heteroalkyl, aryl, and aralkyl, and
when one of R_{4XY} and R_{5XY} is absent, the imidazolyl group to which the absent R_{4XY} or R_{5XY} is connected (i.e., the imidazolyl group having one of R_{4XY} or R_{5XY}, but not the other) is neutral;
R_{3XY} and R_{6XY} are each independently selected from alkyl, perfluoroalkyl, heteroalkyl, aryl, aralkyl, and heteroaryl;
R_{15XY} is selected from alkylene, perfluoroalkylene, heteroalkylene, arylene, aralkylene, and heteroarylene, each optionally substituted with 1, 2, 3, or 4 substituents independently selected from alkyl, perfluoroalkyl, heteroalkyl, and halo;
R_{16XY} is selected from a bond, arylene, and heteroarylene, wherein said arylene and heteroarylene is each optionally substituted with 1, 2, 3, or 4 substituents independently selected from alkyl, perfluoroalkyl, heteroalkyl, and halo;
R_{7XY}, R_{10XY}, R_{11XY}, and R_{14XY} are each independently selected from H, alkyl, perfluoroalkyl, and heteroalkyl; and
R_{8XY}, R_{9XY}, R_{12XY}, and R_{13XY} are each independently selected from hydrogen (H), alkyl, perfluoroalkyl, and heteroalkyl.

13. (canceled)

14. The crosslinked polymer membrane of claim 1, wherein each repeat unit is independently selected from Formula (VI):

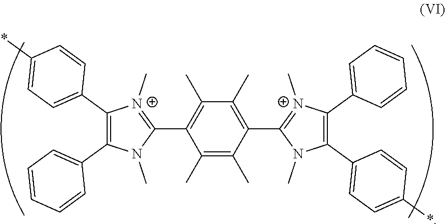

15. The crosslinked polymer membrane of claim 1, wherein each repeat unit is independently selected from Formula (VII):

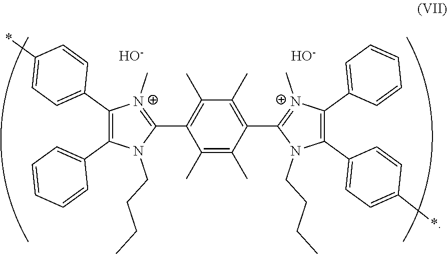

16. A crosslinked polymer membrane, comprising a crosslinked arylimidazolium polymer, wherein:
the crosslinked arylimidazolium polymer comprises a plurality of arylimidazolium polymer chains and one or more crosslinking moiety,
each arylimidazolium polymer chain of the plurality of arylimidazolium polymer chains comprises a plurality of repeat units, wherein each repeat unit is independently selected from Formula (VIII): 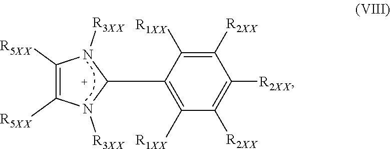
wherein:
R_{1XX} is independently selected from the group consisting of H, methyl, trifluoromethyl, alkyl, perfluoroalkyl, heteroalkyl, alkoxy, perfluoroalkoxy, halo, aryl, heteroaryl group, a crosslinking moiety, and a polymer chain;
R_{2XX} is independently selected from the group consisting of hydrogen, any group, and a polymer chain;
R_{3XX} is independently selected from the group consisting of methyl, trifluoromethyl, alkyl, perfluoroalkyl, heteroalkyl, aryl, alkyl, a polymer chain, and absent; and
R_{5XX} is independently selected from the group consisting of hydrogen, any group, and a polymer chain; and
wherein at least one of R_{1XX}, R_{2XX}, R_{3XX}, and R_{5XX}, is a polymer chain.

17. The crosslinked polymer membrane of claim 1, wherein X⁻ is selected from the group consisting of F⁻, Cl⁻, Br⁻, I⁻, HO⁻, BF₄⁻, PF₆⁻, HCO₃⁻, CH₃CO₂⁻, CH₃SO₃⁻, C₂H₅SO₃⁻, CH₃C₆H₄SO₃⁻, NO₃⁻, and combinations thereof.

18.-21. (canceled)

22. The crosslinked polymer membrane of claim 1, wherein the arylimidazolium polymer chain comprises nitrogen atoms, and at least about 90% of the nitrogen atoms are alkylated.

23. (canceled)

24. The crosslinked polymer membrane of claim 22, wherein at least about 45% of the nitrogen atoms are methylated and at least about 45% of the nitrogen atoms are butylated.

25. (canceled)

26. The crosslinked polymer membrane of claim 1, wherein the one or more crosslinking moiety is covalently bound to a nitrogen atom of a first arylimidazolium polymer chain, and a nitrogen atom of a second arylimidazolium polymer chain; the one or more crosslinking moiety is covalently bound to a first nitrogen atom of a arylimidazolium polymer chain, and a second nitrogen atom of the same arylimidazolium polymer chain; or a combination thereof.

27. The crosslinked polymer membrane of claim 1, wherein the one or more crosslinking moiety is a substituted or unsubstituted 1,3-propane, a substituted or unsubstituted 1,6-hexane, a substituted or unsubstituted 1,8-octane, a substituted or unsubstituted 1,10-decane, a substituted or unsubstituted 1,12-dodecane, a substituted or unsubstituted 1,14-tetradecane, a substituted or unsubstituted α,α′-p-xylene, or a combination thereof, and
wherein the substituted 1,3-propane, 1,6-hexane, 1,8-octane, 1,10-decane, 1,12-dodecane, 1,14-tetradecane, and α,α′-p-xylene are substituted with C1-C₆ alkyl.

28. (canceled)

29. The crosslinked polymer membrane of claim 1, wherein about 1% to about 50% of the arylimidazolium polymer chains are crosslinked.

30. The crosslinked polymer membrane of claim 1, wherein the crosslinked polymer membrane has a thickness of up to about 200 μm.

31. (canceled)

32. The crosslinked polymer membrane of claim 1, wherein an average molecular weight of the plurality of arylimidazolium polymer chains is between about 100 kDa and about 2000 kDa.

33.-34. (canceled)

35. A method of making a crosslinked polymer membrane of claim 1, comprising:
preparing a casting solution of a plurality of arylimidazolium polymer chains, one or more crosslinker, and one or more solvent, and optionally adding KI, NaI, tetraalkyl ammonium iodide, or a combination thereof;
casting the casting solution onto a supporting substrate to form a film; and
heating the film at a temperature between about 80° C. and about 100° C. to form the crosslinked polymer membrane,
wherein:
the crosslinked polymer membrane comprises a plurality of arylimidazolium polymer chains and a crosslinking moiety, and wherein the arylimidazolium polymer chains are connected to the crosslinking moiety through a covalent bond.

36.-55. (canceled)

56. The method of claim 35, wherein the casting solution comprises a ratio of the plurality of arylimidazolium polymer chains to the one or more crosslinker of about 60:40 to about 95:5.

57.-60. (canceled)

61. The crosslinked polymer membrane of claim 1, incorporated into a catalyst layer of a fuel cell, of an electrolyzer, or of another electrochemical device.

62. An electrochemical device comprising the crosslinked polymer membrane of claim 1, wherein the electrochemical device is a fuel cell, an electrolyzer, a redox flow battery, or another electrochemical device.

63. The crosslinked polymer membrane produced by the method of claim 35, incorporated into a catalyst layer of a fuel cell, of an electrolyzer, or of another electrochemical device.

64. An electrochemical device comprising the crosslinked polymer membrane produced by the method of claim 35, wherein the electrochemical device is a fuel cell, an electrolyzer, a redox flow battery, or another electrochemical device.
